(19) United States
(12) Patent Application Publication
(10) Pub. No.: US 2023/0331132 A1
(43) Pub. Date: Oct. 19, 2023

(54) UNMANNED VEHICLE CONTROL SYSTEM, UNMANNED VEHICLE, AND UNMANNED VEHICLE CONTROL METHOD

(71) Applicant: Komatsu Ltd., Tokyo (JP)

(72) Inventor: Yosuke Kadono, Tokyo (JP)

(73) Assignee: Komatsu Ltd., Tokyo (JP)

(21) Appl. No.: 18/028,075

(22) PCT Filed: Oct. 11, 2021
(86) PCT No.: PCT/JP2021/037614

§ 371 Date: Mar. 23, 2023

(30) Foreign Application Priority Data
Oct. 14, 2020 (JP) 2020-173252

(51) Int. Cl. B60P 1/04; G05D 1/02

(52) U.S. Cl. CPC B60P 1/04; G05D 1/0212; G05D 2201/021

(57) ABSTRACT

An unmanned vehicle control system includes a travel control unit that outputs a start command for starting the unmanned vehicle, and a dump body control unit that outputs a dump command for causing a dump body of the unmanned vehicle to perform a dumping operation when it is determined that the unmanned vehicle does not start in spite of the start command.

### FIELD

The present disclosure relates to an unmanned vehicle control system, an unmanned vehicle, and an unmanned vehicle control method.

### BACKGROUND

An unmanned vehicle operates in a wide-area work site such as a mine. As disclosed in Patent Literature 1, an unmanned vehicle may operate in an oil sand mine. The oil sands refer to sandstones containing a high-viscosity mineral oil component.

### CITATION LIST

### Patent Literature

Patent Literature 1: WO 2016/080555 A

### SUMMARY

### Technical Problem

The oil sand is as soft as a sponge. At least part of a tire of the unmanned vehicle may be buried in the oil sand due to the weight of the unmanned vehicle. When the tire of the unmanned vehicle is buried in the oil sand in the stopped state of the unmanned vehicle, there is a possibility that the start of the unmanned vehicle is difficult. When the unmanned vehicle cannot start or the time required for the tire to escape from the oil sand is long, there is a possibility that the productivity of the work site decreases.

An object of the present disclosure is to suppress a decrease in productivity at a work site where an unmanned vehicle operates.

### Solution to Problem

According to an aspect of the present invention, an unmanned vehicle control system comprises: a travel control unit that outputs a start command for starting an unmanned vehicle; and a dump body control unit that outputs a dump command for causing a dump body of the unmanned vehicle to perform a dumping operation when it is determined that the unmanned vehicle does not start in spite of the start command.

### Advantageous Effects of Invention

According to the present disclosure, a decrease in productivity at a work site where an unmanned vehicle operates is suppressed.

### BRIEF DESCRIPTION OF DRAWINGS

FIG. 1 is a schematic diagram illustrating a work site of an unmanned vehicle according to an embodiment.

FIG. 2 is a schematic diagram illustrating a management system of a work site according to the embodiment.

FIG. 3 is a functional block diagram illustrating a management system of a work site according to the embodiment.

FIG. 4 is a schematic diagram for explaining course data and permitted area data according to the embodiment.

FIG. 5 is a configuration diagram illustrating the unmanned vehicle according to the embodiment.

FIG. 6 is a functional block diagram illustrating an unmanned vehicle control system according to the embodiment.

FIG. 7 is a diagram for describing a start condition according to the embodiment.

FIG. 8 is a view illustrating a state of the unmanned vehicle according to the embodiment.

FIG. 9 is a diagram illustrating a state of an unmanned vehicle 2 when a dump command is output in the start control according to the embodiment.

FIG. 10 is a view illustrating a vehicle situation of the unmanned vehicle before the dumping operation is started according to the embodiment.

FIG. 11 is a view illustrating a surrounding situation of the unmanned vehicle before the dumping operation is started according to the embodiment.

FIG. 12 is a schematic diagram illustrating a permitted area according to the embodiment.

FIG. 13 is a diagram for explaining that course data of another unmanned vehicle is changed by a notification from a notification unit according to the embodiment.

FIG. 14 is a diagram for explaining that course data of another unmanned vehicle is generated by a notification from the notification unit according to the embodiment.

FIG. 15 is a diagram for explaining that the position of the load is output to an output device by a notification from the notification unit according to the embodiment.

FIG. 16 is a flowchart illustrating a control method of the unmanned vehicle according to the embodiment.

FIG. 17 is a diagram for explaining start control according to the embodiment.

### DESCRIPTION OF EMBODIMENTS

Hereinafter, embodiments according to the present disclosure will be described with reference to the drawings, but the present disclosure is not limited to the embodiments. The constituent elements of the respective embodiments described below is allowed to be appropriately combined. In some cases, some components are not used.

[Work Site]

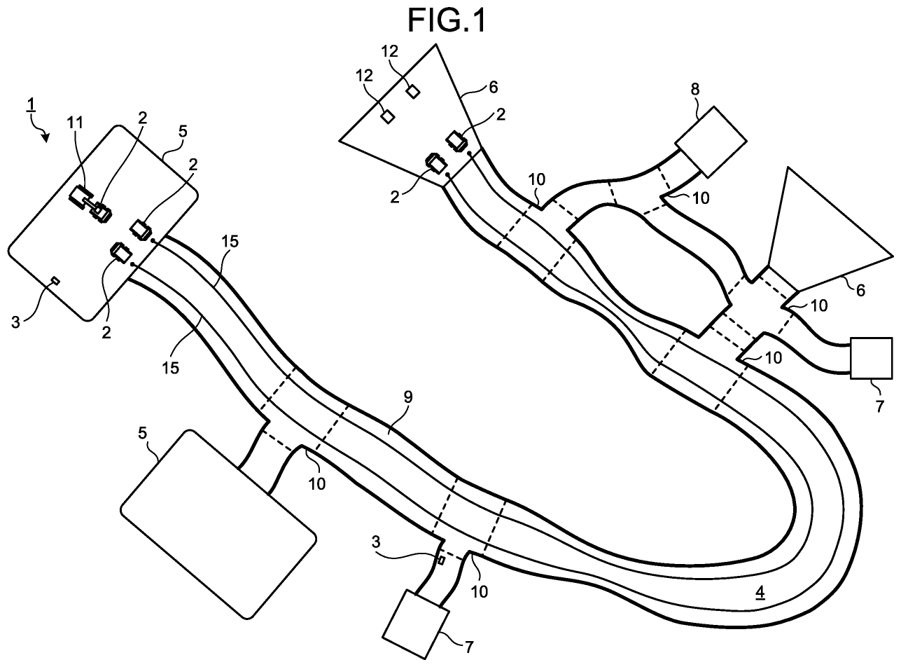

FIG. 1 is a schematic diagram illustrating a work site 1 of an unmanned vehicle 2 according to an embodiment. Examples of the work site 1 include a mine and a quarry. The mine refers to a place or a place of business where minerals are mined. A quarry refers to a place or a place of business where stones are mined. In the work site 1, a plurality of unmanned vehicles 2 is operated. In addition, an auxiliary vehicle 3 operates at the work site 1.

The unmanned vehicle 2 is a work vehicle that operates in an unmanned manner without depending on a driving operation by a driver. The unmanned vehicle 2 is an unmanned dump truck that travels in the work site 1 in an unmanned manner and transports a load. An example of an excavated object excavated at the work site 1 includes the load transported by the unmanned vehicle 2.

The auxiliary vehicle 3 is a manned vehicle that travels in the work site 1 for maintenance, inspection, or management of the work site 1. The manned vehicle refers to a vehicle that operates based on the driving operation of the driver on board.

In the embodiment, the work site 1 is a mine. Examples of the mine include a metal mine for mining metal, a non-metal mine for mining limestone, and a coal mine for mining coal.

A travel area 4 is set at the work site 1. The travel area 4 is an area where the unmanned vehicle 2 can travel. The travel area 4 includes a loading area 5, a discharging area 6, a parking area 7, a fuel filling area 8, a traveling path 9, and an intersection 10.

The loading area 5 is an area in which loading work for loading a load on the unmanned vehicle 2 is performed. In the loading area 5, a loader 11 operates. An example of the loader 11 includes an excavator.

The discharging area 6 is an area where discharging work for discharging a load from the unmanned vehicle 2 is performed. A crusher 12 is provided in the discharging area 6.

The parking area 7 is an area where the unmanned vehicle 2 is parked.

The fuel filling area 8 is an area where the unmanned vehicle 2 is fed.

The traveling path 9 refers to an area where the unmanned vehicle 2 traveling toward at least one of the loading area 5, the discharging area 6, the parking area 7, and the fuel filling area 8 travels. The traveling path 9 is provided so as to connect at least the loading area 5 and the discharging area 6. In the embodiment, the traveling path 9 is connected to each of the loading area 5, the discharging area 6, the parking area 7, and the fuel filling area 8.

The intersection 10 refers to an area where a plurality of traveling paths 9 intersects or an area where one traveling path 9 branches into a plurality of traveling paths 9.

[Management System]

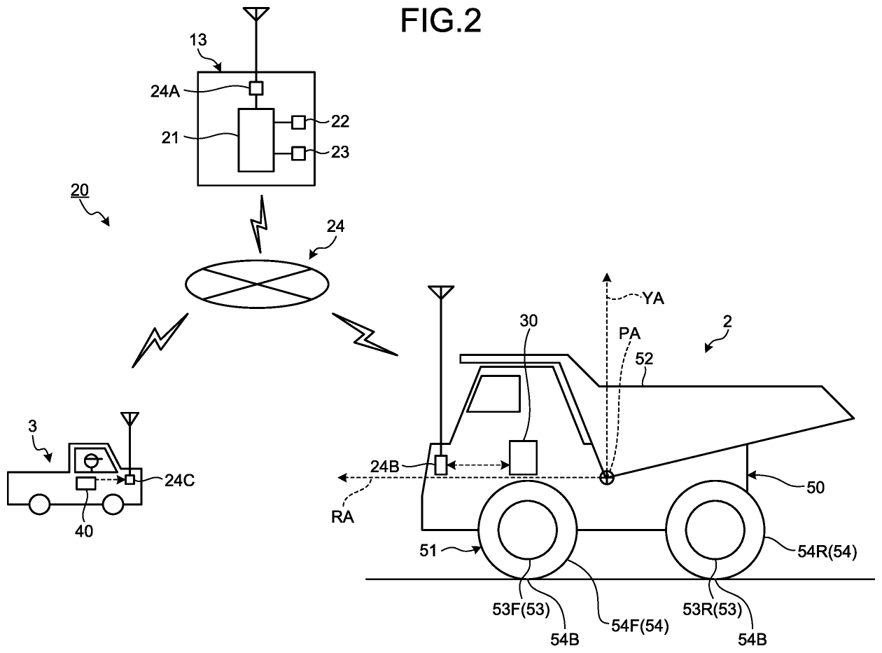

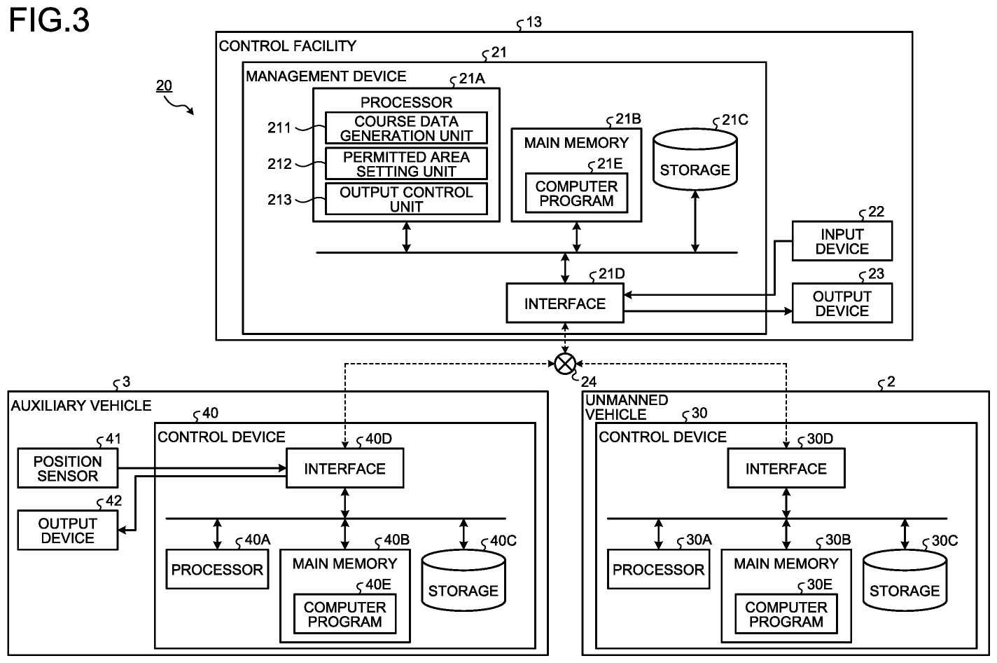

FIG. 2 is a schematic diagram illustrating a management system 20 of the work site 1 according to the embodiment. FIG. 3 is a functional block diagram illustrating the management system 20 of the work site 1 according to the embodiment.

The management system 20 includes a management device 21, an input device 22, an output device 23, and a communication system 24. Each of the management device 21, the input device 22, and the output device 23 is installed in a control facility 13 of the work site 1. An administrator is present in the control facility 13.

The unmanned vehicle 2 includes a control device 30. The auxiliary vehicle 3 includes a control device 40. The management device 21 and the control device 30 of the unmanned vehicle 2 wirelessly communicate with each other via the communication system 24. The management device 21 and the control device 40 of the auxiliary vehicle 3 wirelessly communicate with each other via the communication system 24. A wireless communication device 24A is connected to the management device 21. A wireless communication device 24B is connected to the control device 30. A wireless communication device 24C is connected to the control device 40. The communication system 24 includes the wireless communication device 24A, the wireless communication device 24B, and the wireless communication device 24C.

The input device 22 is operated by the administrator of the control facility 13. The input device 22 is operated by the administrator to generate input data. Examples of the input device 22 include a touch panel, a computer keyboard, a mouse, and an operation button.

The output device 23 outputs output data. Examples of the output device 23 include a display device and a voice output device. Examples of the display device include a flat panel display such as a liquid crystal display or an organic electroluminescent display.

The management device 21 includes a computer system. The management device 21 includes a processor 21A, a main memory 21B, a storage 21C, and an interface 21D. Examples of the processor 21A include a central processing unit (CPU) and a micro processing unit (MPU). Examples of the main memory 21B include a nonvolatile memory and a volatile memory is exemplified. An example of the nonvolatile memory includes a read only memory (ROM). An example of the volatile memory includes a random access memory (RAM). Examples of the storage 21C include a hard disk drive (HDD) and a solid state drive (SSD). Examples of the interface 21D include an input/output circuit and a communication circuit.

A computer program 21E is developed in the main memory 21B. The processor 21A executes processing according to the computer program 21E. The interface 21D is connected to each of the input device 22 and the output device 23.

The management device 21 includes a course data generation unit 211, a permitted area setting unit 212, and an output control unit 213.

The course data generation unit 211 generates course data indicating a traveling condition of the unmanned vehicle 2. The course data generation unit 211 generates course data for each of the plurality of unmanned vehicles 2. The administrator of the control facility 13 operates the input device 22 to input the traveling condition of the unmanned vehicle 2 to the management device 21. The course data generation unit 211 generates course data based on the input data generated by the input device 22. The course data generation unit 211 transmits the course data to the unmanned vehicle 2 via the communication system 24.

The permitted area setting unit 212 generates permitted area data indicating a permitted area for traveling of the unmanned vehicle 2. The permitted area setting unit 212 generates the permitted area data for each of the plurality of unmanned vehicles 2. The permitted area setting unit 212 transmits the permitted area data to the unmanned vehicle 2 via the communication system 24.

The unmanned vehicle 2 operates at the work site 1 based on the course data and the permitted area data transmitted from the management device 21.

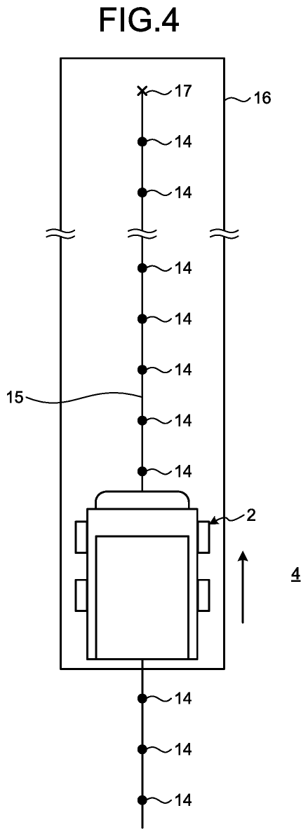

FIG. 4 is a schematic diagram for explaining course data and permitted area data according to the embodiment. The course data defines the traveling condition of the unmanned vehicle 2. The course data includes a course point 14, a travel course 15, a target position of the unmanned vehicle 2, a target traveling speed of the unmanned vehicle 2, a target azimuth of the unmanned vehicle 2, and a topography at the course point 14.

A plurality of course points 14 is set in the travel area 4. The course point 14 defines a target position of the unmanned vehicle 2. The target traveling speed of the unmanned vehicle 2 and the target azimuth of the unmanned vehicle 2 are set in each of the plurality of course points 14. The plurality of course points 14 is set at intervals. The interval between the course points 14 is set to, for example, 1 [m] or more and 5 [m] or less. The intervals between the course points 14 may be uniform or non-uniform.

The travel course 15 refers to a virtual line indicating a target travel route of the unmanned vehicle 2. The travel course 15 is defined by a trajectory passing through the plurality of course points 14. The unmanned vehicle 2 travels in the travel area 4 according to the travel course 15.

The target position of the unmanned vehicle 2 refers to a target position of the unmanned vehicle 2 when passing through the course point 14. The target position of the unmanned vehicle 2 may be defined in a local coordinate system of the unmanned vehicle 2 or may be defined in a global coordinate system.

The target traveling speed of the unmanned vehicle 2 refers to a target traveling speed of the unmanned vehicle 2 when passing through the course point 14.

The target azimuth of the unmanned vehicle 2 refers to a target azimuth of the unmanned vehicle 2 when passing through the course point 14.

The topography at the course point 14 refers to an inclination angle of the surface of the travel area 4 at the course point 14.

The permitted area data defines a permitted area 16 in which the unmanned vehicle 2 is permitted to travel and a stop point 17 of the unmanned vehicle 2. The permitted area 16 is set in the travel area 4. The permitted area 16 is an area where entry of another unmanned vehicle 2A is prohibited. The permitted area 16 is set in the movement direction of the unmanned vehicle 2. When the unmanned vehicle 2 moves forward, at least part of the permitted area 16 is set in front of the unmanned vehicle 2. The permitted area 16 is set in a band shape so as to include the travel course 15. In addition, the permitted area 16 is set to include the unmanned vehicle 2. The length of the permitted area 16 in the movement direction of the unmanned vehicle 2 is, for example, 100 [m] or more and 500 [m] or less. The stop point 17 is set at the distal end portion of the permitted area 16. The traveling speed of the unmanned vehicle 2 is controlled so that the unmanned vehicle 2 can stop at the stop point 17.

The permitted area setting unit 212 sets the permitted area 16 for each of the plurality of unmanned vehicles 2. The permitted area setting unit 212 sets the permitted areas 16 so that the plurality of permitted areas 16 do not overlap each other. The permitted area setting unit 212 sequentially updates the permitted area 16 as the unmanned vehicle 2 travels. The permitted area setting unit 212 sequentially releases the permitted area 16 through which the unmanned vehicle 2 has passed. The permitted area setting unit 212 sequentially extends the permitted area 16 before the unmanned vehicle 2 passes in the movement direction of the unmanned vehicle 2. When the permitted area 16 where the unmanned vehicle 2 has passed is released, the another unmanned vehicle 2A can travel. When the permitted area 16 before the unmanned vehicle 2 passes is extended, the unmanned vehicle 2 continues to travel. When an event that the permitted area 16 cannot be extended occurs, the unmanned vehicle 2 stops at the stop point 17. An example of an event in which the permitted area 16 cannot be extended includes an event in which the another unmanned vehicle 2A is stopped in front of the permitted area 16.

The output control unit 213 causes the output device 23 to output the output data. In a case where the output device 23 includes a display device, the output control unit 213 causes the output device 23 to display the display data.

[Auxiliary Vehicle]

As illustrated in FIGS. 2 and 3, the auxiliary vehicle 3 includes the control device 40, the wireless communication device 24C, a position sensor 41, and an output device 42.

The control device 40 includes a computer system. The control device 40 includes a processor 40A, a main memory 40B, a storage 40C, and an interface 40D. A computer program 40E is developed in the main memory 40B. The interface 40D is connected to each of the position sensor 41 and the output device 42.

The position sensor 41 detects the position of the auxiliary vehicle 3. The position of the auxiliary vehicle 3 is detected using a global navigation satellite system (GNSS). The global navigation satellite system includes a global positioning system (GPS). The global navigation satellite system detects a position in a global coordinate system defined by coordinate data of latitude, longitude, and altitude. The global coordinate system refers to a coordinate system fixed to the earth. The position sensor 41 includes a GNSS receiver and detects the position of the auxiliary vehicle 3 in the global coordinate system.

The output device 42 is disposed in the cab of the auxiliary vehicle 3. The output device 42 outputs output data. Examples of the output device 42 include a display device and a voice output device.

[Unmanned Vehicle]

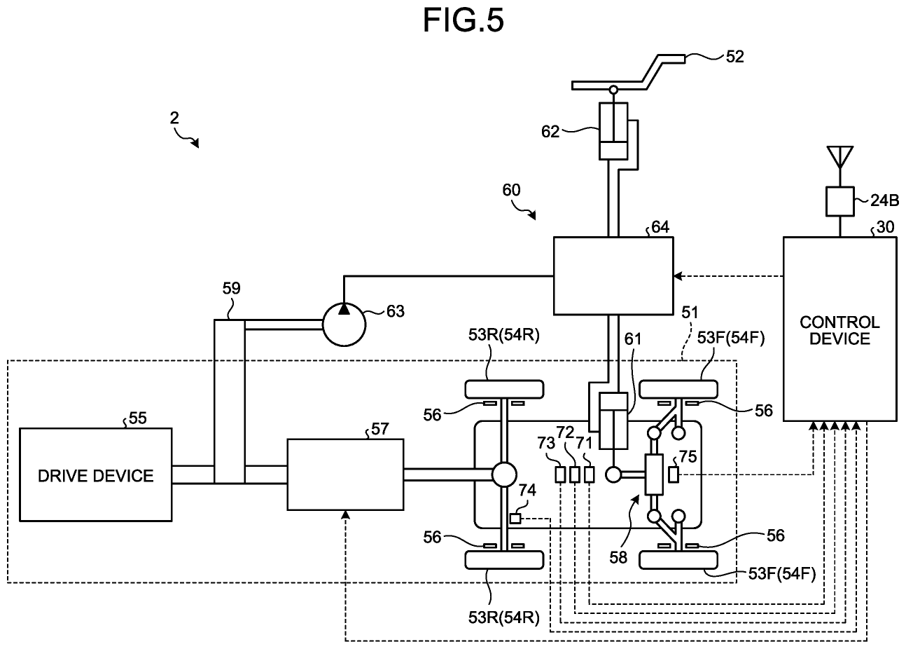

FIG. 5 is a configuration diagram illustrating the unmanned vehicle 2 according to the embodiment. As illustrated in FIGS. 2, 3, and 5, the unmanned vehicle 2 includes the control device 30, the wireless communication device 24B, a vehicle body 50, a traveling device 51, a dump body 52, a hydraulic device 60, a position sensor 71, an azimuth sensor 72, an inclination sensor 73, a speed sensor 74, and a steering sensor 75.

As illustrated in FIG. 2, the local coordinate system of the unmanned vehicle 2 is defined by the pitch axis PA, the roll axis RA, and the yaw axis YA. The pitch axis PA extends in the left-right direction (vehicle width direction) of the unmanned vehicle 2. The roll axis RA extends in the front-rear direction of the unmanned vehicle 2. The yaw axis YA extends in the vertical direction of the unmanned vehicle 2. The pitch axis PA and the roll axis RA are orthogonal to each other. The roll axis RA and the yaw axis YA are orthogonal to each other. The yaw axis YA and the pitch axis PA are orthogonal to each other.

The control device 30 includes a computer system. As illustrated in FIG. 3, the control device 30 includes a processor 30A, a main memory 30B, a storage 30C, and an interface 30D. A computer program 30E is developed in the main memory 30B.

The vehicle body 50 includes a vehicle body frame. The vehicle body 50 is supported by the traveling device 51. The vehicle body 50 supports the dump body 52.

The traveling device 51 causes the unmanned vehicle 2 to travel. The traveling device 51 moves the unmanned vehicle 2 forward or backward. At least part of the traveling device 51 is disposed below the vehicle body 50. The traveling device 51 includes wheels 53, tires 54, a drive device 55, a brake device 56, a transmission device 57, and a steering device 58.

The tire 54 is mounted on the wheel 53. The wheels 53 includes a front wheel 53F and a rear wheel 53R. The tires 54 includes a front tire 54F mounted on the front wheel 53F and a rear tire 54R mounted on the rear wheel 53R.

The drive device 55 generates a driving force for starting or accelerating the unmanned vehicle 2. Examples of the drive device 55 include an internal combustion engine and an electric motor. An example of the internal combustion engine includes a diesel engine.

The brake device 56 generates a braking force for stopping or decelerating the unmanned vehicle 2. Examples of the brake device 56 include a disc brake and a drum brake.

The transmission device 57 transmits the driving force generated by the drive device 55 to the wheel 53. Transmission device 57 includes a forward clutch and a backward clutch. When the connection state between the forward clutch and the backward clutch is switched, the forward movement and the backward movement of the unmanned vehicle 2 are switched. The wheel 53 is rotated by a driving force generated by the drive device 55. When the wheel 53 rotates in a state where the tire 54 is in contact with the road surface of the work site, the unmanned vehicle 2 travels in the work site 1.

The steering device 58 generates a steering force for adjusting the traveling direction of the unmanned vehicle 2. The traveling direction of the unmanned vehicle 2 moving forward refers to an azimuth toward the front portion of the vehicle body 50. The traveling direction of the unmanned vehicle 2 traveling backward refers to an azimuth toward the rear portion of the vehicle body 50. The steering device 58 steers the wheel 53. The traveling direction of the unmanned vehicle 2 is adjusted by steering the wheel 53.

The wheel 53 includes a drive wheel to which the driving force from the drive device 55 is transmitted and a steering wheel steered by the steering device 58. In the embodiment, the drive wheel is the rear wheel 53R. The steering wheel is the front wheel 53F.

The dump body 52 is a member on which a load is loaded. At least part of the dump body 52 is disposed above the vehicle body 50. The dump body 52 performs a dumping operation and a lowering operation. The dump body 52 is adjusted to the dump posture and the loading posture by the dumping operation and the lowering operation. The dump posture refers to a posture in which the dump body 52 is raised. The loading posture refers to a posture in which the dump body 52 is lowered.

The dumping operation refers to an operation of causing the dump body 52 to being away from the vehicle body 50 and incline in the dumping direction. The dumping direction is the rear side of the vehicle body 50. In the embodiment, the dumping operation includes raising the front end portion of the dump body 52 and inclining the dump body 52 rearward. By the dumping operation, the loading surface of the dump body 52 is inclined downward toward the rear side.

The lowering operation refers to an operation of causing the dump body 52 to approach the vehicle body 50. In the embodiment, the lowering operation includes lowering the front end portion of the dump body 52.

When the discharge work is performed, the dump body 52 performs a dumping operation so as to change from the loading posture to the dump posture. In a case where a load is loaded on the dump body 52, the load is discharged rearward from the rear end portion of the dump body 52 by the dumping operation. When the loading work is performed, the dump body 52 is adjusted to the loading posture.

The hydraulic device 60 includes a steering cylinder 61, a hoist cylinder 62, a hydraulic pump 63, and a valve device 64.

The steering cylinder 61 generates a steering force for steering the front wheel 53F in the steering device 58. The steering cylinder 61 is a hydraulic cylinder. The steering device 58 includes the steering cylinder 61. The front wheel 53F is connected to the steering cylinder 61 via a link mechanism of the steering device 58. When the steering cylinder 61 is expanded and contracted, the front wheel 53F is steered.

The hoist cylinder 62 generates a lifting force for operating the dump body 52. The hoist cylinder 62 is a hydraulic cylinder. The dump body 52 is connected to the hoist cylinder 62. When the hoist cylinder 62 is expanded and contracted, the dump body 52 performs a dumping operation and a lowering operation.

The hydraulic pump 63 is operated by the driving force generated by the drive device 55. Part of the driving force generated by the drive device 55 is transmitted to the hydraulic pump 63 via a power transmission mechanism 59. The hydraulic pump 63 discharges hydraulic oil for expanding and contracting each of the steering cylinder 61 and the hoist cylinder 62.

The valve device 64 adjusts a flowing state of the hydraulic oil supplied to each of the steering cylinder 61 and the hoist cylinder 62. The valve device 64 operates based on a control command from the control device 30. The valve device 64 includes a first flow rate regulating valve capable of adjusting the flow rate and the direction of the hydraulic oil supplied to the steering cylinder 61 and a second flow rate regulating valve capable of adjusting the flow rate and the direction of the hydraulic oil supplied to the hoist cylinder 62. The steering cylinder 61 is expanded and contracted by hydraulic oil supplied from the hydraulic pump 63 via the valve device 64. The hoist cylinder 62 is expanded and contracted by the hydraulic oil supplied from the hydraulic pump 63 via the valve device 64.

The position sensor 71 detects the position of the unmanned vehicle 2. The position of the unmanned vehicle 2 is detected using a global navigation satellite system (GNSS). The position sensor 71 includes a GNSS receiver and detects the position of the unmanned vehicle 2 in the global coordinate system.

The azimuth sensor 72 detects an azimuth of the unmanned vehicle 2. The azimuth of the unmanned vehicle 2 includes a yaw angle Yθ of the unmanned vehicle 2. The yaw angle Yθ refers to an inclination angle of the unmanned vehicle 2 around the yaw axis YA. An example of the azimuth sensor 72 includes a gyro sensor.

The inclination sensor 73 detects a posture of the unmanned vehicle 2. The posture of the unmanned vehicle 2 includes an inclination angle of the vehicle body 50. The inclination angle of the vehicle body 50 includes a pitch angle Pθ and a roll angle Rθ of the vehicle body 50. The pitch angle Pθ refers to an inclination angle of the vehicle body 50 about the pitch axis PA. The roll angle Rθ refers to an inclination angle of the vehicle body 50 about the roll axis RA. An example of the inclination sensor 73 includes an inertial measurement unit (IMU).

In a state where a lower end portion 54B of the tire 54 is in contact with the ground parallel to the horizontal plane, each of the pitch axis PA and the roll axis RA is parallel to the horizontal plane. In a state where a lower end portion 54B of the tire 54 is in contact with the ground parallel to the horizontal plane, each of the pitch angle Pθ and the roll angle Rθ is 0 [°]. The lower end portion 54B of the tire 54 refers to part of the outer peripheral face of the tire 54 disposed at the lowermost side in the vertical direction parallel to the yaw axis YA.

The speed sensor 74 detects a traveling speed of the unmanned vehicle 2. An example of the speed sensor 74 includes a pulse sensor that detects rotation of the wheel 53.

The steering sensor 75 detects a steering angle of the steering device 58. An example of the steering sensor 75 includes a potentiometer.

The control device 30 is disposed in the vehicle body 50. The control device 30 outputs a control command for controlling the traveling device 51. The control command output from the control device 30 includes a drive command for operating the drive device 55, a brake command for operating the brake device 56, a forward/backward movement command for operating the transmission device 57, and a steering command for operating the steering device 58. The drive device 55 generates a driving force for starting or accelerating the unmanned vehicle 2 based on the drive command output from the control device 30. The brake device 56 generates a braking force for stopping or decelerating the unmanned vehicle 2 based on the brake command output from the control device 30. The transmission device 57 switches between forward movement and backward movement of the unmanned vehicle 2 based on the forward/backward movement command output from the control device 30. The steering device 58 generates a steering force for causing the unmanned vehicle 2 to travel straight or swing on the basis of the steering command output from the control device 30.

[Control System]

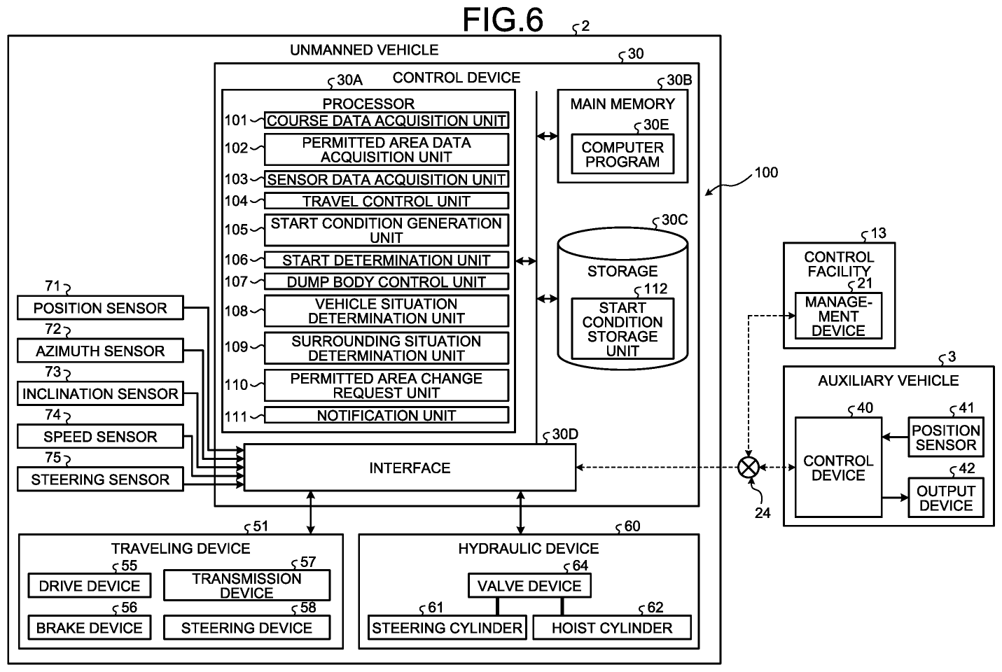

FIG. 6 is a functional block diagram illustrating a control system 100 of the unmanned vehicle 2 according to the embodiment. The control system 100 includes the control device 30, the traveling device 51, the hydraulic device 60, the position sensor 71, the azimuth sensor 72, the inclination sensor 73, the speed sensor 74, and the steering sensor 75.

The interface 30D is connected to each of the traveling device 51, the hydraulic device 60, the position sensor 71, the azimuth sensor 72, the inclination sensor 73, the speed sensor 74, and the steering sensor 75.

The control device 30 includes a course data acquisition unit 101, a permitted area data acquisition unit 102, a sensor data acquisition unit 103, a travel control unit 104, a start condition generation unit 105, a start determination unit 106, a dump body control unit 107, a vehicle situation determination unit 108, a surrounding situation determination unit 109, a permitted area change request unit 110, a notification unit 111, and a start condition storage unit 112.

The processor 30A functions as the course data acquisition unit 101, the permitted area data acquisition unit 102, the sensor data acquisition unit 103, the travel control unit 104, the start condition generation unit 105, the start determination unit 106, the dump body control unit 107, the vehicle situation determination unit 108, the surrounding situation determination unit 109, the permitted area change request unit 110, and the notification unit 111. The storage 30C functions as the start condition storage unit 112.

The course data acquisition unit 101 acquires the course data transmitted from the course data generation unit 211 via the interface 30D. When the course data generation unit 211 updates the course data, the course data acquisition unit 101 acquires the updated course data. The course data acquisition unit 101 acquires course data each time the course data is updated.

The permitted area data acquisition unit 102 acquires the permitted area data transmitted from the permitted area setting unit 212 via the interface 30D. When the permitted area setting unit 212 updates the permitted area data, the permitted area data acquisition unit 102 acquires the updated permitted area data. The permitted area data acquisition unit 102 acquires the permitted area data each time the permitted area data is updated.

The sensor data acquisition unit 103 acquires detection data of the position sensor 71, detection data of the azimuth sensor 72, detection data of the inclination sensor 73, detection data of the speed sensor 74, and detection data of the steering sensor 75.

The travel control unit 104 controls the traveling device 51 based on the course data acquired by the course data acquisition unit 101 and the permitted area data acquired by the permitted area data acquisition unit 102. When the permitted area 16 is not extended, the travel control unit 104 controls the traveling speed of the unmanned vehicle 2 so that the unmanned vehicle 2 can stop at the stop point 17 of the permitted area 16. When the permitted area 16 is extended, the travel control unit 104 continues the traveling of the unmanned vehicle 2.

The travel control unit 104 controls the traveling device 51 so that the unmanned vehicle 2 travels along the travel course 15. In the embodiment, the travel control unit 104 controls the traveling device 51 so that the unmanned vehicle 2 travels in a state where the center of the unmanned vehicle 2 in the vehicle width direction matches the travel course 15.

The travel control unit 104 controls the traveling device 51 so that the actual position of the unmanned vehicle 2 when passing through the course point 14 is the target position based on the detection data of the position sensor 71. The travel control unit 104 controls the traveling device 51 so that the unmanned vehicle 2 travels along the travel course 15 based on the detection data of the position sensor 71.

The travel control unit 104 controls the traveling device 51 so that the actual azimuth of the unmanned vehicle 2 when passing through the course point 14 is the target azimuth based on the detection data of the azimuth sensor 72. The travel control unit 104 controls the traveling device 51 so that there is no deviation between the actual position of the unmanned vehicle 2 and the target position of the unmanned vehicle 2 defined by the course point 14 and so that the actual azimuth of the unmanned vehicle 2 when passing through the course point 14 is the target azimuth.

The travel control unit 104 calculates the posture of the unmanned vehicle 2 at the course point 14 based on the detection data of the inclination sensor 73 when the unmanned vehicle 2 passes through the course point 14 and the topography at the course point 14.

The travel control unit 104 controls the traveling device 51 so that the actual traveling speed of the unmanned vehicle 2 when passing through the course point 14 is the target traveling speed based on the detection data of the speed sensor 74.

The travel control unit 104 controls the traveling device 51 so that the actual steering angle of the unmanned vehicle 2 when passing through the course point 14 is the target steering angle based on the detection data of the steering sensor 75.

In addition, the travel control unit 104 performs start control of the unmanned vehicle 2. The start control refers to control for starting the unmanned vehicle 2 in the stopped state. Start control of the unmanned vehicle 2 is started with the dump body 52 in the loading posture.

In the start control, the travel control unit 104 outputs a start command Ca for starting the unmanned vehicle 2 in a predetermined movement direction. In the embodiment, the predetermined movement direction is the front direction of the unmanned vehicle 2. That is, the start command Ca moves the unmanned vehicle 2 forward.

The start condition generation unit 105 generates a start condition used for start control of the unmanned vehicle 2. The start condition includes a control program related to start control. The start condition generated by the start condition generation unit 105 is stored in the start condition storage unit 112. The travel control unit 104 performs start control of the unmanned vehicle 2 based on the start condition stored in the start condition storage unit 112.

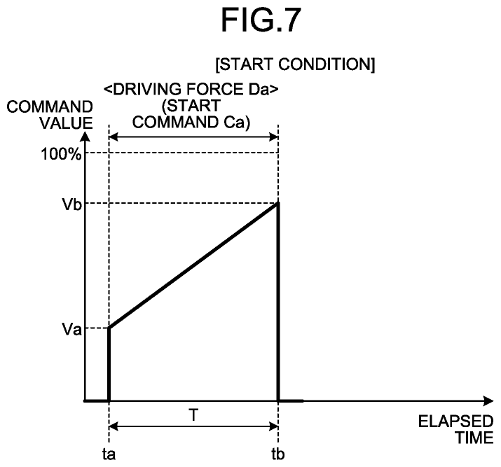

FIG. 7 is a diagram for describing a start condition according to the embodiment. When the unmanned vehicle 2 is started, the start command Ca is output from the travel control unit 104. In FIG. 7, the vertical axis represents the command value of the start command Ca, and the horizontal axis represents the elapsed time from a time point ta at which the output of the start command Ca is started. The time point ta is a start time point of the start control by the start command Ca. The start condition indicates a relationship between the start command Ca for starting the unmanned vehicle 2 and the elapsed time from the time point ta of the start control. The start command Ca is output for a specified time T from the time point ta to a time point tb. The time point tb is an end time point of the start control by the start command Ca.

The start command Ca includes a drive command for causing the drive device 55 of the unmanned vehicle 2 to generate a driving force Da. The larger the command value of the start command Ca, the larger the driving force Da generated by the drive device 55, and the smaller the command value of the start command Ca, the smaller the driving force Da generated by the drive device 55. When the command value is 100 [%], the drive device 55 outputs the maximum value of the driving force that the drive device 55 is allowed to generate. That is, when the command value is 100 [%], the drive device 55 operates in the full accelerator state.

In the example illustrated in FIG. 7, the start condition is set so that the command value of the start command Ca does not reach 100 [%]. A command value Va of the start command Ca at the time point ta is smaller than 50 [%]. The command value Va of the start command Ca at the time point ta may be 50 [%] or larger than 50 [%]. A command value Vb of the start command Ca at the time point tb is larger than the command value Va and smaller than 100 [%]. The command value of the start command Ca is set so as to monotonically increase from the time point ta to the time point tb. The output of the start command Ca is stopped at the time point tb when the specified time T has elapsed since the start of the output of the start command Ca.

The command value Va of the start command Ca is calculated so that the unmanned vehicle 2 in the stopped state starts at the time point ta. The start condition generation unit 105 calculates the target acceleration of the unmanned vehicle 2 based on the target traveling speed of the unmanned vehicle 2 defined by the course data. The start condition generation unit 105 calculates the target driving force of the drive device 55 that generates the target acceleration based on the motion equation obtained by modeling each of the unmanned vehicle 2 and the travel area 4. Correlation data (table) indicating the relationship between the target driving force and the command value is determined in advance. The start condition generation unit 105 determines the command value Va for generating the target driving force at the time point ta based on the correlation data.

When the start control is performed based on the start condition, the travel control unit 104 starts outputting the start command Ca at the time point ta. When the start command Ca is output, the unmanned vehicle 2 can start. The drive device 55 generates the driving force Da based on the start command Ca.

The command value Va at the time point ta is a theoretical value calculated based on the motion equation described above. For example, there is a possibility that the unmanned vehicle 2 cannot start at the time point ta even when the output of the start command Ca is started due to the actual state of the unmanned vehicle 2 or the actual state of the travel area 4. In the embodiment, since the command value of the start command Ca monotonously increases from the time point ta to the time point tb, the unmanned vehicle 2 can start at the specified time T.

The command value of the start command Ca may reach 100 [%]. For example, the command value Vb of the start command Ca at the time point tb may be 100 [%]. The command value Va of the start command Ca at the time point ta may be 100 [%].

The start determination unit 106 determines whether the unmanned vehicle 2 has started in response to the start command Ca. The start determination unit 106 determines whether the unmanned vehicle 2 has started based on the specified time T and the detection data of the speed sensor 74. The start determination unit 106 can determine whether the unmanned vehicle 2 has started acceleration based on the detection data of the speed sensor 74. When it is determined that the unmanned vehicle 2 has started accelerating in the specified time T, the start determination unit 106 determines that the unmanned vehicle 2 has started. When it is determined that the unmanned vehicle 2 does not start accelerating in the specified time T, the start determination unit 106 determines that the unmanned vehicle 2 does not start.

Note that the start determination unit 106 may determine whether the unmanned vehicle 2 has started based on the traveling speed of the unmanned vehicle 2, the acceleration of the unmanned vehicle 2, and the movement distance of the unmanned vehicle 2. The start determination unit 106 may estimate the traveling speed of the unmanned vehicle 2 from at least one piece of detection data of the detection data of the speed sensor 74 including the pulse sensor, the detection data of the position sensor 71 including the GNSS receiver, and the detection data of the inclination sensor 73 including the inertial measurement unit. The start determination unit 106 may determine whether the unmanned vehicle 2 has started in consideration of the skid situation of the tire 54.

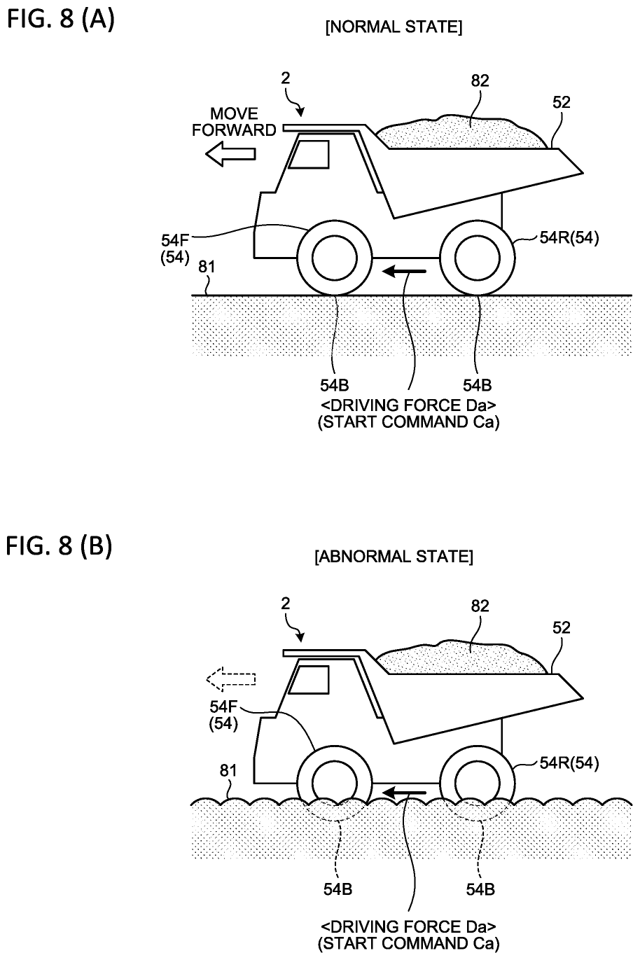

FIG. 8 is a diagram illustrating a state of the unmanned vehicle 2 on which start control is performed according to the embodiment. The state of the unmanned vehicle 2 includes a normal state and an abnormal state. Before the unmanned vehicle 2 starts, the dump body 52 is in the loading posture.

As illustrated in FIG. 8(A), the normal state of the unmanned vehicle 2 includes a state in which the lower end portion 54B of the tire 54 is in contact with a road surface 81. That is, the normal state of the unmanned vehicle 2 refers to a state in which the tire 54 is not buried under a road surface 81 or a state in which the tire 54 does not enter a groove present in the road surface 81. When the road surface 81 is stiff, the unmanned vehicle 2 is likely to be in a normal state.

As illustrated in FIG. 8(B), the abnormal state of the unmanned vehicle 2 includes a state in which at least part of the tire 54 is buried under the road surface 81 or a state in which the tire enters a groove present in the road surface 81. When the road surface 81 is soft, the unmanned vehicle 2 is highly likely to be in an abnormal state. In addition, in a case where a load 82 is loaded on the dump body 52 and the weight of the unmanned vehicle 2 is large, the unmanned vehicle 2 is highly likely to be in an abnormal state. Examples of the soft road surface 81 include a road surface of the oil sand and a road surface muddy by rainwater.

The start condition illustrated in FIG. 7 is a start condition used when the unmanned vehicle 2 is in the normal state. That is, the start command Ca is used when the unmanned vehicle 2 in the normal state is started. When the unmanned vehicle 2 is in an abnormal state, there is a possibility that the unmanned vehicle 2 does not start in spite of the start command Ca.

When the start determination unit 106 determines that the unmanned vehicle 2 does not start in spite of the start command Ca, the dump body control unit 107 outputs a dump command Cd for causing the dump body 52 of the unmanned vehicle 2 to perform a dumping operation. The dump body control unit 107 outputs the dump command Cd to the valve device 64 so that the dump body 52 performs a dumping operation by the hoist cylinder 62.

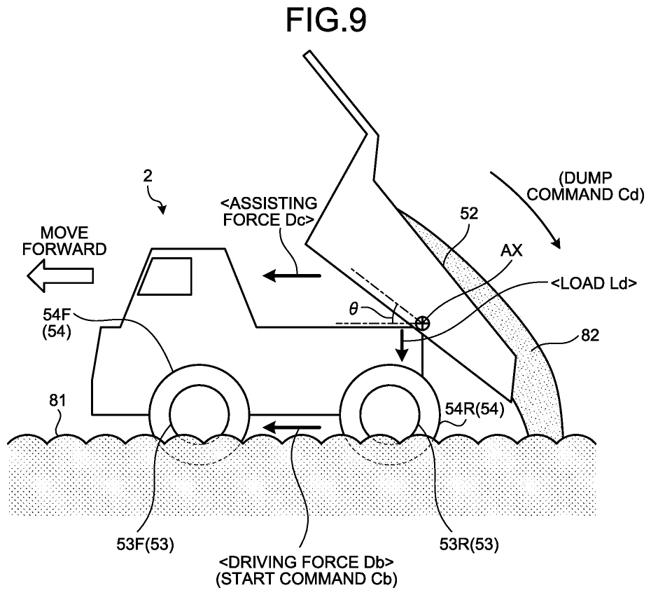

FIG. 9 is a diagram illustrating a state of the unmanned vehicle 2 when the dump command Cd is output in the start control according to the embodiment. When it is determined that the unmanned vehicle 2 does not start in spite of the start command Ca, the dump body control unit 107 outputs the dump command Cd for causing the dump body 52 to perform a dumping operation. The dump body 52 performs a dumping operation from the loading posture based on the dump command Cd.

The dump body control unit 107 outputs the dump command Cd in a state where the load 82 is loaded on the dump body 52. When the dump body 52 performs a dumping operation so as to change from the loading posture to the dump posture, the load 82 is discharged from the dump body 52. The load 82 is discharged behind the vehicle body 50.

The dump body 52 performs a dumping operation so as to be inclined rearward which is a dumping direction. When the dump body 52 performs the dumping operation, an assisting force Dc for moving the unmanned vehicle 2 forward is generated. The assisting force Dc is defined based on an inclination angle θ of the dump body 52 with respect to the horizontal plane, a weight M of the load 82, and the like. Even when the unmanned vehicle 2 does not move forward by the start command Ca, the dump body 52 performs the dumping operation to generate the assisting force Dc for moving the unmanned vehicle 2 forward, so that the unmanned vehicle 2 can start. Even in a buried state in which the tire 54 is buried under the road surface 81 or enters a groove present in the road surface 81, the tire 54 can escape from the buried state by the dump body 52 performing a dumping operation. When the tire 54 escapes from the buried state, the unmanned vehicle 2 can start.

The travel control unit 104 outputs a start command Cb for starting the unmanned vehicle 2 in a state where the dump command Cd is output from the dump body control unit 107. The start command Cb for starting the unmanned vehicle 2 includes a drive command for causing the drive device 55 of the unmanned vehicle 2 to generate the driving force db. That is, the dump body control unit 107 outputs the dump command Cd in a state where a driving force db for starting the unmanned vehicle 2 is generated. Since the assisting force Dc for moving the unmanned vehicle 2 forward is generated in a state where the driving force db for moving the unmanned vehicle 2 forward is generated, the unmanned vehicle 2 can start even in a state where the tire 54 is buried under the road surface 81 or in a state where the tire 54 enters a groove present in the road surface 81.

The driving force db generated by the start command Cb starts the unmanned vehicle 2 in a predetermined movement direction. The dumping operation includes inclining the dump body 52 in a dumping direction opposite to the movement direction of the unmanned vehicle 2. In the embodiment, the movement direction of the unmanned vehicle 2 is the front direction. The dumping direction is the rear direction of the unmanned vehicle 2.

The start command Ca is output when the dump body 52 is in the loading posture. The start command Cb is output when the dump body 52 is in the dump posture. The start command Ca and the start command Cb may be continuously output. When the start command Ca is output and it is determined that the unmanned vehicle 2 does not start in spite of the start command Ca, the output of the start command Ca may be stopped, and the start command Cb may be output after the output of the start command Ca is stopped.

The driving force db output by the start command Cb may be equal to the driving force Da output by the start command Ca. The driving force db may be larger than the driving force Da. In the embodiment, the driving force db is the maximum value of the driving force that the drive device 55 of the unmanned vehicle 2 is allowed to generate. That is, the command value of the start command Cb is 100 [%)].

The period during which the driving force db is generated may be longer than the specified time T during which the driving force Da is generated. In the embodiment, the travel control unit 104 continues the generation of the driving force db until the start determination unit 106 determines that the unmanned vehicle 2 has started.

In the dumping operation, the dump body 52 rotates about a rotation axis AX. The rotation axis AX is defined at a rear portion of the dump body 52. The rotation axis AX extends in the vehicle width direction. When the dump body 52 performs the dumping operation from the loading posture, the center of gravity of the dump body 52 moves backward. As the center of gravity of the dump body 52 moves backward, a load Ld in the vertical direction applied to the rear wheel 53R increases. That is, the load Ld applied to the rear wheel 53R in the dump posture after the dumping operation is started is larger than the load Ld applied to the rear wheel 53R in the loading posture before the dumping operation is started. Since the load Ld applied to the rear wheel 53R increases due to the dumping operation, the frictional force between the rear tire 54R and the road surface 81 increases. Accordingly, in the start control, the skid of the rear tire 54R is suppressed.

In the start control, when the dump body 52 performs a dumping operation, the travel control unit 104 controls the steering device 58 so that the front wheel 53F is in a straight traveling state. The travel control unit 104 controls the steering device 58 so that the front wheel 53F is in the straight traveling state based on the detection data of the steering sensor 75. The dump body control unit 107 outputs the dump command Cd in a state in which the front wheel 53F is in the straight traveling state. When the dump body 52 takes a dump posture in a state in which the front wheel 53F is in the non-straight traveling state, there is a possibility that the weight balance of the unmanned vehicle 2 is unstable. When the weight balance of the unmanned vehicle 2 is unstable, there is a possibility that smooth start of the unmanned vehicle 2 is difficult. When the dump body 52 performs a dumping operation with the front wheel 53F in the straight traveling state, the unmanned vehicle 2 can smoothly start.

The vehicle situation determination unit 108 determines whether the dumping operation is allowed to be started based on the vehicle situation of the unmanned vehicle 2 before the dumping operation is started. The dump body control unit 107 outputs the dump command Cd based on the result of determination by the vehicle situation determination unit 108.

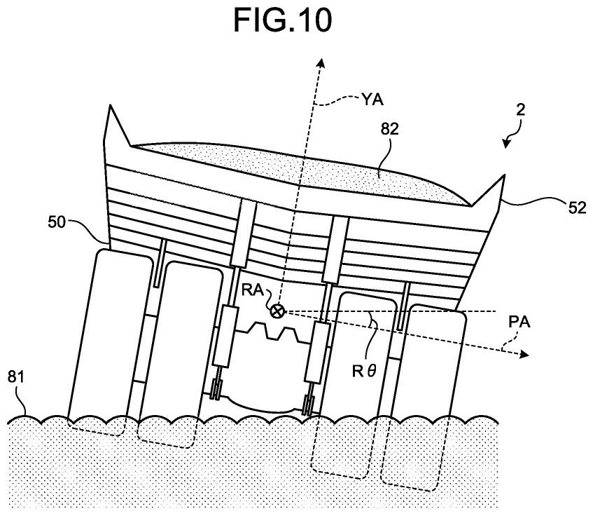

FIG. 10 is a diagram illustrating a vehicle situation of the unmanned vehicle 2 before the dumping operation is started according to the embodiment. The vehicle situation includes a posture of the vehicle body 50 of the unmanned vehicle 2 that supports the dump body 52. The posture of the vehicle body 50 includes an inclination angle of the vehicle body 50 with respect to a horizontal plane. In the embodiment, the inclination angle of the vehicle body 50 with respect to the horizontal plane includes the roll angle Rθ of the vehicle body 50 with respect to the horizontal plane. As illustrated in FIG. 10, there is a possibility that the vehicle body 50 is inclined in the rotation direction around the roll axis RA before the dumping operation is started. When the dumping operation is started in a state where the vehicle body 50 is inclined in the rotation direction around the roll axis RA, there is a possibility that the weight balance of the unmanned vehicle 2 is unstable. When the weight balance of the unmanned vehicle 2 is unstable, there is a possibility that it is difficult to smoothly start the unmanned vehicle 2, and the work efficiency of the unmanned vehicle 2 decreases.

The vehicle situation determination unit 108 recognizes the roll angle Rθ based on the detection data of the inclination sensor 73. A threshold value is determined in advance for the roll angle RO. When the roll angle Rθ is less than the threshold value, the vehicle situation determination unit 108 determines that the dumping operation is allowed to be started. When the roll angle Rθ is equal to or larger than the threshold value, the vehicle situation determination unit 108 determines that the dumping operation is not allowed to be started. When the vehicle situation determination unit 108 determines that the dumping operation is allowed to be started, the dump body control unit 107 outputs the dump command Cd. When the vehicle situation determination unit 108 determines that the dumping operation is not allowed to be started, the dump body control unit 107 does not output the dump command Cd. As a result, a decrease in the work efficiency of the unmanned vehicle 2 is suppressed.

Note that the vehicle situation may include the pitch angle Pθ of the vehicle body 50 with respect to the horizontal plane. The vehicle situation determination unit 108 may determine that the dumping operation is allowed to be started in a case where the pitch angle Pθ is less than the threshold value, and may determine that the dumping operation is not allowed to be started in a case where the pitch angle Pθ is equal to or greater than the threshold value. Note that the vehicle situation may include the situation of the hydraulic device 60. The vehicle situation determination unit 108 may determine that the dumping operation is allowed to be started when the hydraulic device 60 is normal, and may determine that the dumping operation is not allowed to be started when the hydraulic device 60 is abnormal.

The surrounding situation determination unit 109 determines whether the dumping operation is allowed to be started based on the surrounding situation of the unmanned vehicle 2 before the dumping operation is started. The dump body control unit 107 outputs the dump command Cd based on the result of determination by the surrounding situation determination unit 109.

The surrounding situation determination unit 109 calculates an estimated area 83 of the load 82 to be discharged from the dump body 52 by the dumping operation before the dumping operation is started. The estimated area 83 is an area occupied by the load 82 on the road surface 81 estimated by the dumping operation. The surrounding situation determination unit 109 can calculate the estimated area 83 based on the position and the azimuth of the unmanned vehicle 2. The position of the unmanned vehicle 2 is detected by the position sensor 71. The azimuth of the unmanned vehicle 2 is detected by the azimuth sensor 72. The surrounding situation determination unit 109 can calculate the estimated area 83 based on the detection data of the position sensor 71 and the detection data of the azimuth sensor 72.

An example of the surrounding situation includes a position of the moving object around the unmanned vehicle 2 with respect to the estimated area 83. Examples of the moving object include the another unmanned vehicle 2A and the auxiliary vehicle 3. In addition, an example of the surrounding situation includes a position of a non-moving object around the unmanned vehicle 2 with respect to the estimated area 83. Examples of the non-moving object include an electric light, a stone, a bank, a fuel supply facility, and a sign present at a work site. In addition, an example of the surrounding situation includes course data of the another unmanned vehicle 2A around the unmanned vehicle 2 with respect to the estimated area 83.

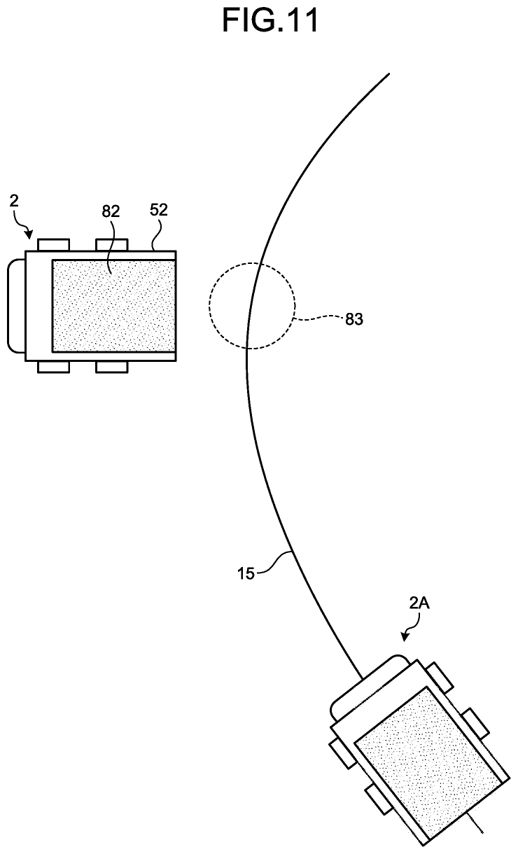

FIG. 11 is a diagram illustrating a surrounding situation of the unmanned vehicle 2 before the dumping operation according to the embodiment is started. FIG. 11 illustrates an example in which the surrounding situation is course data of the another unmanned vehicle 2A. As illustrated in FIG. 11, there is a possibility that the travel course 15 of the another unmanned vehicle 2A is provided in the estimated area 83 before the dumping operation is started. When the dumping operation is started in a state where the travel course 15 is provided in the estimated area 83, there is a possibility that traveling of the another unmanned vehicle 2A is hindered by the discharged load 82. As a result, productivity at the work site may be reduced.

The surrounding situation determination unit 109 acquires the course data of the another unmanned vehicle 2A from the course data generation unit 211. When the travel course 15 of the another unmanned vehicle 2A is not provided in the estimated area 83, the surrounding situation determination unit 109 determines that the dumping operation is allowed to be started. When the travel course 15 of the another unmanned vehicle 2A is provided in the estimated area 83, the surrounding situation determination unit 109 determines that the dumping operation is not allowed to be started. When the surrounding situation determination unit 109 determines that the dumping operation is allowed to be started, the dump body control unit 107 outputs the dump command Cd. When the surrounding situation determination unit 109 determines that the dumping operation is not allowed to be started, the dump body control unit 107 does not output the dump command Cd. This suppresses a decrease in productivity at the work site.

In addition, when the dumping operation is started in a state where the another unmanned vehicle 2A or the auxiliary vehicle 3 is approaching the estimated area 83 before the dumping operation is started, there is a possibility that traveling of the another unmanned vehicle 2A or the auxiliary vehicle 3 is hindered by the discharged load 82. As a result, productivity at the work site may be reduced.

The position of the another unmanned vehicle 2A is detected by the position sensor 71 of the another unmanned vehicle 2A. The position of the auxiliary vehicle 3 is detected by the position sensor 41. The surrounding situation determination unit 109 can determine whether the another unmanned vehicle 2A or the auxiliary vehicle 3 is approaching the estimated area 83 based on the detection data of the position sensor 71 of the another unmanned vehicle 2A and the detection data of the position sensor 41 of the auxiliary vehicle 3. When the another unmanned vehicle 2A and the auxiliary vehicle 3 are not approaching the estimated area 83 or when the another unmanned vehicle 2A and the auxiliary vehicle 3 are away from the estimated area 83, the surrounding situation determination unit 109 determines that the dumping operation is allowed to be started. When the another unmanned vehicle 2A or the auxiliary vehicle 3 is approaching the estimated area 83, the surrounding situation determination unit 109 determines that the dumping operation is not allowed to be started. When the surrounding situation determination unit 109 determines that the dumping operation is allowed to be started, the dump body control unit 107 outputs the dump command Cd. When the surrounding situation determination unit 109 determines that the dumping operation is not allowed to be started, the dump body control unit 107 does not output the dump command Cd. This suppresses a decrease in productivity at the work site.

When the start determination unit 106 determines that the unmanned vehicle 2 does not start in spite of the start command Ca, the permitted area change request unit 110 requests the permitted area setting unit 212 to expand the permitted area 16 before the dumping operation is started. The permitted area change request unit 110 transmits a request command Cr for requesting expansion of the permitted area 16 to the permitted area setting unit 212 via the communication system 24. The dump body control unit 107 outputs the dump command Cd after the permitted area 16 is expanded.

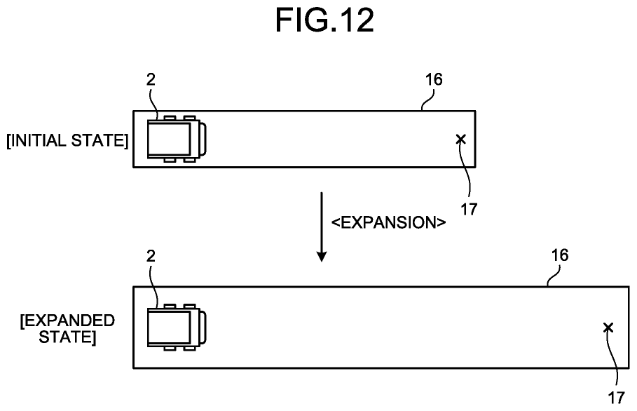

FIG. 12 is a schematic diagram illustrating the permitted area 16 according to the embodiment. As illustrated in FIG. 12, when it is determined that the unmanned vehicle 2 does not start in spite of the start command Ca, the permitted area change request unit 110 outputs the request command Cr so that the permitted area 16 is changed from the initial state to the enlarged state before the dumping operation is started.

When the start command Ca is output from the travel control unit 104, the permitted area 16 in the initial state is set. Further, when the unmanned vehicle 2 is normally traveling in the travel area 4, the permitted area 16 in the initial state is set. The permitted area setting unit 212 sets the permitted area 16 in the initial state in the unmanned vehicle 2 before the dumping operation is started.

When the unmanned vehicle 2 does not start in spite of the start command Ca and the dumping operation is performed, the permitted area 16 in the enlarged state is set. The permitted area 16 in the enlarged state is larger than the permitted area 16 in the initial state. When it is determined that the unmanned vehicle 2 does not start in spite of the start command Ca, the permitted area setting unit 212 enlarges the permitted area 16 in the initial state and sets the permitted area 16 in the enlarged state based on the request command Cr from the permitted area change request unit 110 before the dumping operation is started.

In the movement direction of the unmanned vehicle 2, the dimension of the permitted area 16 in the enlarged state is larger than the dimension of the permitted area 16 in the initial state. In addition, in the vehicle width direction of the unmanned vehicle 2, the dimension of the permitted area 16 in the enlarged state is larger than the dimension of the permitted area 16 in the initial state. When it is determined that the unmanned vehicle 2 does not start in spite of the start command Ca, the permitted area setting unit 212 expands the permitted area 16 in the initial state in each of the movement direction and the vehicle width direction based on the request command Cr from the permitted area change request unit 110. Note that the permitted area setting unit 212 may expand the permitted area 16 in the initial state in either one of the movement direction or the vehicle width direction.

When the dumping operation is started in the start control, the assisting force Dc is applied to the driving force db. Therefore, there is a possibility that the unmanned vehicle 2 vigorously starts. The permitted area 16 prohibits entry of the another unmanned vehicle 2A. As the permitted area 16 is enlarged, even when the unmanned vehicle 2 vigorously starts, it is suppressed that the unmanned vehicle 2 goes out of the permitted area 16. Therefore, contact between the unmanned vehicle 2 and the another unmanned vehicle 2A is suppressed.

When the start determination unit 106 determines that the unmanned vehicle 2 does not start in spite of the start command Ca, the notification unit 111 notifies a target outside the unmanned vehicle 2 that the dumping operation is to be started.

An example of the target outside the unmanned vehicle 2 includes the course data generation unit 211 of the management device 21. In addition, examples of the target outside the unmanned vehicle 2 include the another unmanned vehicle 2A and the auxiliary vehicle 3.

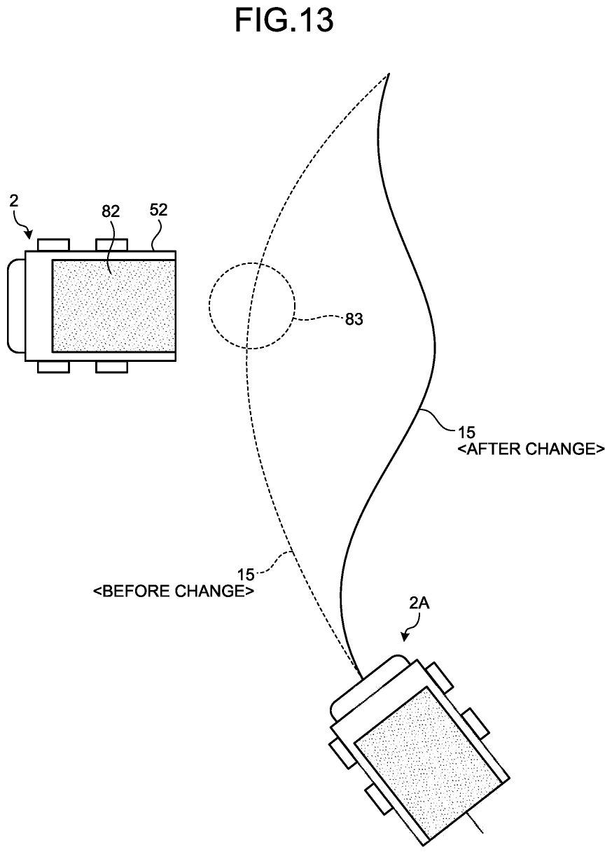

FIG. 13 is a diagram for explaining that the course data of the another unmanned vehicle 2A is changed by the notification from the notification unit 111 according to the embodiment.

When it is determined that the unmanned vehicle 2 does not start in spite of the start command Ca, the notification unit 111 notifies the course data generation unit 211 that the dumping operation is to be started before the dumping operation is started. In addition, the notification unit 111 notifies the course data generation unit 211 of the estimated area 83 of the load 82 discharged from the dump body 52 by the dumping operation.

The course data generation unit 211 generates course data of the another unmanned vehicle 2A based on the estimated area 83 notified from the notification unit 111. In the embodiment, the course data generation unit 211 determines whether the travel course 15 of the another unmanned vehicle 2A is provided in the estimated area 83 based on the position of the estimated area 83 notified from the notification unit 111. When it is determined that the travel course 15 of the another unmanned vehicle 2A is provided in the estimated area 83, the course data generation unit 211 generates course data of the another unmanned vehicle 2A so that the travel course 15 of the another unmanned vehicle 2A is away from the estimated area 83. The travel course 15 of the another unmanned vehicle 2A is changed so as to avoid the estimated area 83. In addition, the travel course 15 of the another unmanned vehicle 2A is changed so as not to overlap with the another estimated area 83 traveling along the travel course 15. The course data generation unit 211 transmits the changed course data to the another unmanned vehicle 2A. The another unmanned vehicle 2A travels along the changed travel course 15. Since the changed travel course 15 is away from the estimated area 83, the another unmanned vehicle 2A can travel so as to avoid the estimated area 83. The dump body control unit 107 can output the dump command Cd so that the load 82 is discharged to the estimated area 83 after the travel course 15 of the another unmanned vehicle 2A is changed to be away from the estimated area 83. Since the load 82 is prevented from hindering the travel of the another unmanned vehicle 2A, a decrease in productivity of the work site is suppressed.

When the start determination unit 106 determines that the unmanned vehicle 2 does not start in spite of the start command Ca, the notification unit 111 may notify the auxiliary vehicle 3 of the start of the dumping operation and the estimated area 83 of the load 82 before the dumping operation is started. The control device 40 of the auxiliary vehicle 3 causes the output device 42 of the auxiliary vehicle 3 to output the position of the estimated area 83 notified from the notification unit 111. The driver of the auxiliary vehicle 3 can check the position of the estimated area 83 output to the output device 42 and travel in the travel area 4 so as to avoid the estimated area 83. Since the load 82 is prevented from hindering the movement of the auxiliary vehicle 3, a decrease in productivity at the work site is suppressed.

In addition, the notification unit 111 notifies a target outside the unmanned vehicle 2 that the dumping operation has ended.

Examples of the target outside the unmanned vehicle 2 include the course data generation unit 211 and the output control unit 213 of the management device 21. In addition, examples of the target outside the unmanned vehicle 2 include the another unmanned vehicle 2A and the auxiliary vehicle 3.

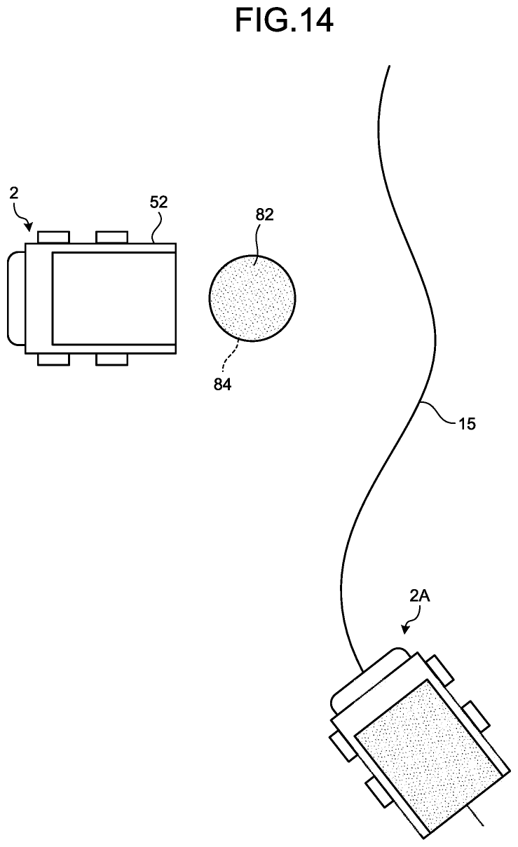

FIG. 14 is a diagram for explaining that course data of the another unmanned vehicle 2A is generated by the notification from the notification unit 111 according to the embodiment.

In a case where the dumping operation is performed in the start control, the notification unit 111 notifies the course data generation unit 211 that the dumping operation has ended after the end of the dumping operation. The surrounding situation determination unit 109 calculates a discharge area 84 of the load 82 discharged from the dump body 52 by the dumping operation after the end of the dumping operation. The discharge area 84 is an area occupied by the load 82 on the road surface 81 generated by the dumping operation. The surrounding situation determination unit 109 can calculate the discharge area 84 of the load 82 based on the detection data of the position sensor 71 and the detection data of the azimuth sensor 72 when the dumping operation is performed. The notification unit 111 notifies the course data generation unit 211 of the discharge area 84.

The course data generation unit 211 generates course data of the another unmanned vehicle 2A based on the discharge area 84 of the load 82 notified from the notification unit 111. In the embodiment, the course data generation unit 211 generates the course data of the another unmanned vehicle 2A so that the travel course 15 of the another unmanned vehicle 2A is away from the discharge area 84 based on the position of the discharge area 84 of the load 82 notified from the notification unit 111. The travel course 15 of the another unmanned vehicle 2A is created so as to avoid the discharge area 84. The course data generation unit 211 transmits the generated course data to the another unmanned vehicle 2A. The another unmanned vehicle 2A travels along the travel course 15. Since the travel course 15 of the another unmanned vehicle 2A is away from the discharge area 84, the another unmanned vehicle 2A can travel so as to avoid the discharge area 84. This prevents the load 82 in the discharge area 84 from hindering the travel of the another unmanned vehicle 2A.

Note that the notification unit 111 may notify the auxiliary vehicle 3 of the end of the dumping operation and the discharge area 84 of the load 82 after the end of the dumping operation. The control device 40 of the auxiliary vehicle 3 causes the output device 42 of the auxiliary vehicle 3 to output the position of the discharge area 84 notified from the notification unit 111. The driver of the auxiliary vehicle 3 can check the position of the discharge area 84 output to the output device 42 and travel in the travel area 4 so as to avoid the discharge area 84. This prevents the load 82 in the discharge area 84 from hindering the travel of the auxiliary vehicle 3.

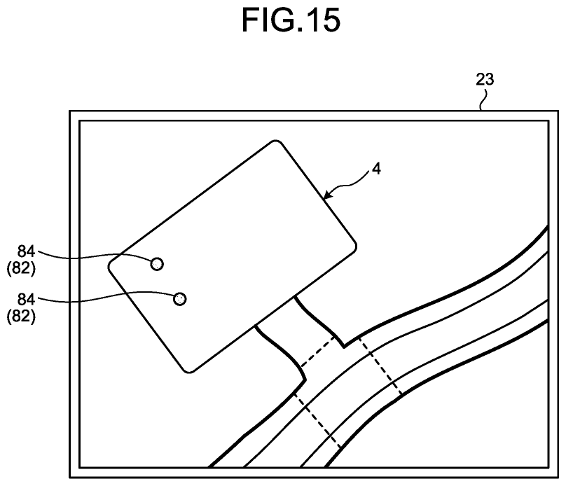

FIG. 15 is a diagram for explaining that the discharge area 84 of the load 82 is output to the output device 23 according to the notification from the notification unit 111 according to the embodiment.

In a case where the dumping operation is performed in the start control, the notification unit 111 notifies the output control unit 213 of the end of the dumping operation and the discharge area 84 of the load 82 after the end of the dumping operation.

The output control unit 213 causes the output device 23 to output the discharge area 84 of the load 82 transmitted from the notification unit 111. As illustrated in FIG. 15, the output control unit 213 causes the output device 23 to display a map image indicating the position of the discharge area 84 in the travel area 4. When the map image indicating the discharge area 84 is displayed on the output device 23, the administrator of the control facility 13 can recognize the position of the discharge area 84.

Furthermore, the output control unit 213 may cause the output device 23 to output that the dumping operation has ended. The output control unit 213 may cause the output device 23 to output that the travel area 4 in the discharge area 84 is required to be maintained. Note that the output control unit 213 may notify an operator of the motor grader or the dozer that the travel area 4 in the discharge area 84 is required to be maintained.

[Control Method]

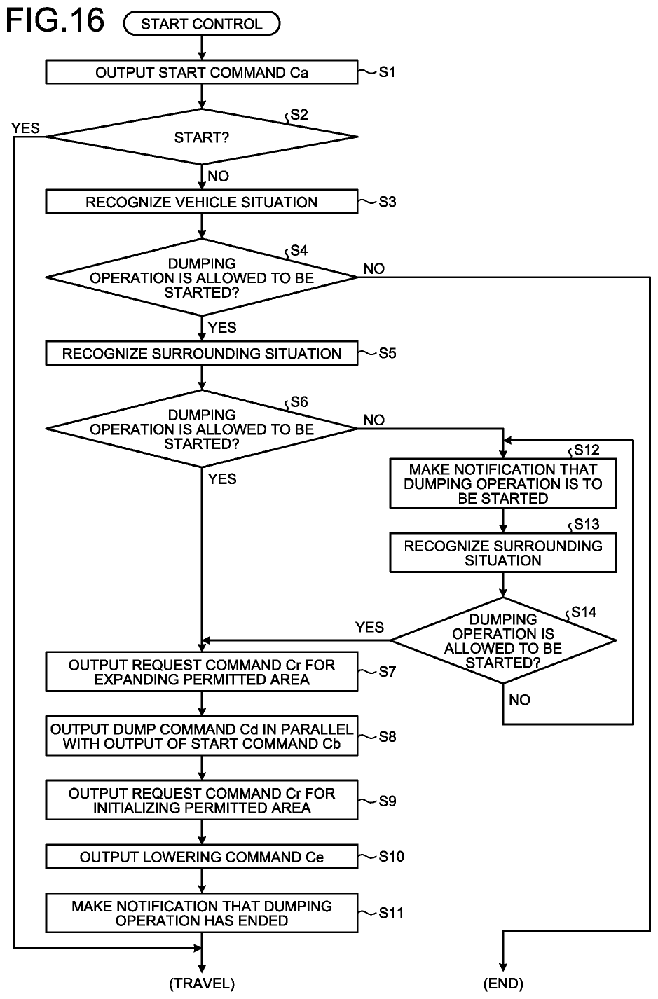

FIG. 16 is a flowchart illustrating a control method of the unmanned vehicle 2 according to the embodiment. In the following description, the start control when the unmanned vehicle 2 in the stopped state starts to move forward at the work site 1 will be described.

The travel control unit 104 outputs the start command Ca to the drive device 55 in order to start the start of the unmanned vehicle 2 (step S1).

The start determination unit 106 determines whether the unmanned vehicle 2 has started in response to the start command Ca based on the specified time T and the detection data of the speed sensor 74 (step S2).

In step S2, when it is determined that the unmanned vehicle 2 starts in response to the start command Ca (step S2: Yes), the start control ends. The unmanned vehicle 2 travels in the work site 1 according to the course data.

In step S2, when it is determined that the unmanned vehicle 2 does not start in spite of the start command Ca (step S2: No), the vehicle situation determination unit 108 recognizes the vehicle situation of the unmanned vehicle 2 before the dumping operation is started (step S3).

In the embodiment, the vehicle situation determination unit 108 acquires the roll angle Rθ of the vehicle body 50 from the inclination sensor 73 as the vehicle situation. The vehicle situation determination unit 108 recognizes the roll angle Rθ of the vehicle body 50.

The vehicle situation determination unit 108 determines whether the dumping operation is allowed to be started based on the recognized vehicle situation (step S4).

When the roll angle Rθ is less than the threshold value, the vehicle situation determination unit 108 determines that the dumping operation is allowed to be started. When the roll angle Rθ is equal to or larger than the threshold value, the vehicle situation determination unit 108 determines that the dumping operation is not allowed to be started.

In step S4, when it is determined that the dumping operation is allowed to be started (step S4: Yes), the surrounding situation determination unit 109 recognizes the surrounding situation of the unmanned vehicle 2 before the dumping operation is started (step S5).

The surrounding situation determination unit 109 calculates the estimated area 83 of the load 82 to be discharged from the dump body 52 by the dumping operation based on the position and the azimuth of the unmanned vehicle 2. The surrounding situation determination unit 109 recognizes course data of the another unmanned vehicle 2A with respect to the estimated area 83 as the surrounding situation.

The surrounding situation determination unit 109 determines whether the dumping operation is allowed to be started based on the recognized surrounding situation (step S6).

When the travel course 15 of the another unmanned vehicle 2A is not provided in the estimated area 83, the surrounding situation determination unit 109 determines that the dumping operation is allowed to be started. When the travel course 15 of the another unmanned vehicle 2A is provided in the estimated area 83, the surrounding situation determination unit 109 determines that the dumping operation is not allowed to be started.

Note that the surrounding situation determination unit 109 may determine that the dumping operation is not allowed to be started when the another unmanned vehicle 2A or the auxiliary vehicle 3 approaches or exists in the estimated area 83, and may determine that the dumping operation is allowed to be started when the another unmanned vehicle 2A or the auxiliary vehicle 3 is away from the estimated area 83. The surrounding situation determination unit 109 can determine whether the another unmanned vehicle 2A approaches or exists in the estimated area 83 based on the detection data of the position sensor 71 of the another unmanned vehicle 2A. The surrounding situation determination unit 109 can determine whether the auxiliary vehicle 3 approaches or exists in the estimated area 83 based on the detection data of the position sensor 41 of the auxiliary vehicle 3.

In step S6, when it is determined that the dumping operation is allowed to be started (step S6: Yes), the permitted area change request unit 110 outputs the request command Cr for requesting expansion of the permitted area 16 to the permitted area setting unit 212 (step S7).

After the permitted area 16 is expanded, the dump body control unit 107 outputs the dump command Cd for causing the dump body 52 of the unmanned vehicle 2 to perform a dumping operation. In the embodiment, the dump body control unit 107 outputs the dump command Cd in parallel with the output of the start command Cb from the travel control unit 104 (step S8).

The driving force db for starting the unmanned vehicle 2 is generated by the output of the start command Cb. The dump body control unit 107 outputs the dump command Cd in a state where the driving force db for starting the unmanned vehicle 2 is generated. In a state where the driving force db for starting the unmanned vehicle 2 is generated, the dump body 52 performs the dumping operation, whereby the assisting force Dc for starting the unmanned vehicle 2 is generated. As a result, the unmanned vehicle 2 can start.

The driving force db generated when the dump body 52 performs the dumping operation may be larger than or equal to the driving force Da generated in step S1. In the embodiment, the drive device 55 outputs the maximum value of the driving force that the drive device 55 is allowed to generate. The drive device 55 operates in a full accelerator state.

After the unmanned vehicle 2 starts, the permitted area change request unit 110 outputs the request command Cr to the permitted area setting unit 212 so that the permitted area 16 is in the initial state (step S9).

In addition, after the unmanned vehicle 2 starts, the dump body control unit 107 outputs a lowering command Ce for lowering the dump body 52 (step S10).

The notification unit 111 notifies the target outside the unmanned vehicle 2 that the dumping operation has ended after the end of the dumping operation. In the embodiment, the notification unit 111 notifies the course data generation unit 211 and the output control unit 213 that the dumping operation has ended (step S11).

As a result, the course data generation unit 211 can generate the course data of the another unmanned vehicle 2A so that the another unmanned vehicle 2A avoids the discharge area 84. The output control unit 213 can cause the output device 23 to output the discharge area 84.

The unmanned vehicle 2 started by the start control travels in the work site 1 according to the course data.

In step S6, when it is determined that the dumping operation is not allowed to be started (step S6: No), the notification unit 111 notifies a target outside the unmanned vehicle 2 that the dumping operation is to be started. In the embodiment, the notification unit 111 notifies the course data generation unit 211 that the start of the dumping operation and the estimated area 83. In the embodiment, the notification unit 111 notifies the auxiliary vehicle 3 that the start of the dumping operation and the estimated area 83 (step S12).

When the start of the dumping operation and the estimated area 83 is notified to the course data generation unit 211, the course data generation unit 211 can generate the course data of the another unmanned vehicle 2A so that the another unmanned vehicle 2A avoids the estimated area 83.

When the start of the dumping operation and the estimated area 83 is notified to the auxiliary vehicle 3, the auxiliary vehicle 3 can travel so as to avoid the estimated area 83.

After the start of the dumping operation and the estimated area 83 is notified, the surrounding situation determination unit 109 recognizes the surrounding situation of the unmanned vehicle 2 (step S13).

The surrounding situation determination unit 109 determines whether the dumping operation is allowed to be started based on the recognized surrounding situation (step S14).

For example, according to the notification of the start of the dumping operation and the estimated area 83, in a case where the travel course 15 of the another unmanned vehicle 2A is generated so as to avoid the estimated area 83, in a case where the another unmanned vehicle 2A travels so as to be away from the estimated area 83, or in a case where the auxiliary vehicle 3 travels so as to avoid the estimated area 83, the surrounding situation determination unit 109 determines that the dumping operation is allowed to be started.

In step S14, when it is determined that the dumping operation is allowed to be started (step S14: Yes), the process from step S7 to step S11 is performed.

In step S14, in a case where it is determined that the dumping operation is not allowed to be started (step S14: No), the process of step S12 is performed. The process of step S12, the process of step S13, and the process of step S14 are performed until it is determined that the dumping operation is allowed to be started.

In step S4, when it is determined that the dumping operation is not allowed to be started (step S4: No), the dumping operation is not performed. The start control ends.

[Effects]

As described above, according to the embodiment, the dump body control unit 107 outputs the dump command Cd for causing the dump body 52 of the unmanned vehicle 2 to perform the dumping operation when it is determined that the unmanned vehicle 2 does not start in spite of the start command Ca. When the dump body 52 performs the dumping operation, the assisting force Dc for starting the unmanned vehicle 2 is generated. When the assisting force Dc is generated, the unmanned vehicle 2 that was not able to start in spite of the start command Ca can start. Since the unmanned vehicle 2 can be started, a decrease in productivity at the work site is suppressed.

The dump body control unit 107 outputs the dump command Cd in a state where the load 82 is loaded on the dump body 52. As a result, the large assisting force Dc is generated.

The dump body control unit 107 outputs the dump command Cd in a state where the driving force db for starting the unmanned vehicle 2 is generated. As a result, the unmanned vehicle 2 can start based on the driving force db and the assisting force Dc.

The driving force db starts the unmanned vehicle 2 in a predetermined movement direction. In the dumping operation, the dump body 52 is inclined in a dumping direction opposite to the movement direction of the unmanned vehicle 2. In the embodiment, the driving force db starts the unmanned vehicle 2 forward. The dumping direction is the rear direction of the unmanned vehicle 2. As a result, in a state where the driving force db for moving the unmanned vehicle 2 forward is generated, the assisting force Dc for moving the unmanned vehicle 2 forward is generated.

In the embodiment, the dump body 52 performs a dumping operation in a state where the load 82 is loaded. When the dumping operation is started in a state where the load 82 is loaded on the dump body 52, the center of gravity of the load 82 moves to the rear portion of the unmanned vehicle 2. When the center of gravity of the load 82 moves to the rear portion of the unmanned vehicle 2, a moment around the center of gravity of the vehicle body 50 changes, or a load distribution acting on the hoist cylinder 62 changes, so that the load applied to the front wheel 53F and the rear wheel 53R changes, and the load Ld applied to the rear wheel 53R, which is the drive wheel, increases. That is, in the embodiment, the relative position between the rear wheel 53R and the rotation axis AX of the dump body 52 is determined so that the load Ld applied to the rear wheel 53R after the dumping operation is started is larger than the load Ld applied to the rear wheel 53R before the dumping operation is started. Since the load Ld applied to the rear wheel 53R increases by the dumping operation, the frictional force between the rear tire 54R and the road surface 81 increases. Accordingly, in the start control, the skid of the rear tire 54R is suppressed.

The unmanned vehicle 2 has the front wheel 53F which is the steering wheel. The dump body control unit 107 outputs the dump command Cd in a state in which the front wheel 53F is in the straight traveling state. Since the dump body 52 takes the dump posture in a state in which the front wheel 53F is in the straight traveling state, the weight balance of the unmanned vehicle 2 is suppressed from becoming unstable. Therefore, the unmanned vehicle 2 can smoothly start.

The dump body control unit 107 outputs the dump command Cd based on the vehicle situation of the unmanned vehicle 2 before the dumping operation is started. On the basis of the vehicle situation of the unmanned vehicle 2, propriety of the dumping operation of the dump body 52 is determined. When it is determined that the dumping operation is inappropriate, the dumping operation is not performed. When the dumping operation is determined to be appropriate, the dumping operation is performed. As a result, a decrease in the work efficiency of the unmanned vehicle 2 is suppressed.

The dump body control unit 107 outputs the dump command Cd based on the surrounding situation of the unmanned vehicle 2 before the dumping operation is started. Propriety of the dumping operation of the dump body 52 is determined based on the surrounding situation of the unmanned vehicle 2. When it is determined that the dumping operation is inappropriate, the dumping operation is not performed. When the dumping operation is determined to be appropriate, the dumping operation is performed. This suppresses a decrease in productivity at the work site.

When it is determined that the unmanned vehicle 2 does not start in spite of the start command Ca, the permitted area 16 is expanded before the dumping operation is started. When the assisting force Dc is generated by the dumping operation, there is a possibility that the unmanned vehicle 2 starts vigorously. The permitted area 16 prohibits entry of the another unmanned vehicle 2A. As the permitted area 16 is enlarged, even when the unmanned vehicle 2 vigorously starts, it is suppressed that the unmanned vehicle 2 goes out of the permitted area 16. Therefore, contact between the unmanned vehicle 2 and the another unmanned vehicle 2A is suppressed.

The notification unit 111 notifies a target outside the unmanned vehicle 2 that the dumping operation is to be started before the dumping operation is started. This prevents the load 82 from hindering the travel of the another unmanned vehicle 2A or the auxiliary vehicle 3. Therefore, a decrease in productivity at the work site is suppressed.

The notification unit 111 notifies a target outside the unmanned vehicle 2 that the dumping operation has ended. This prevents the load 82 from hindering the travel of the another unmanned vehicle 2A or the auxiliary vehicle 3. Therefore, a decrease in productivity at the work site is suppressed.

### OTHER EMBODIMENTS

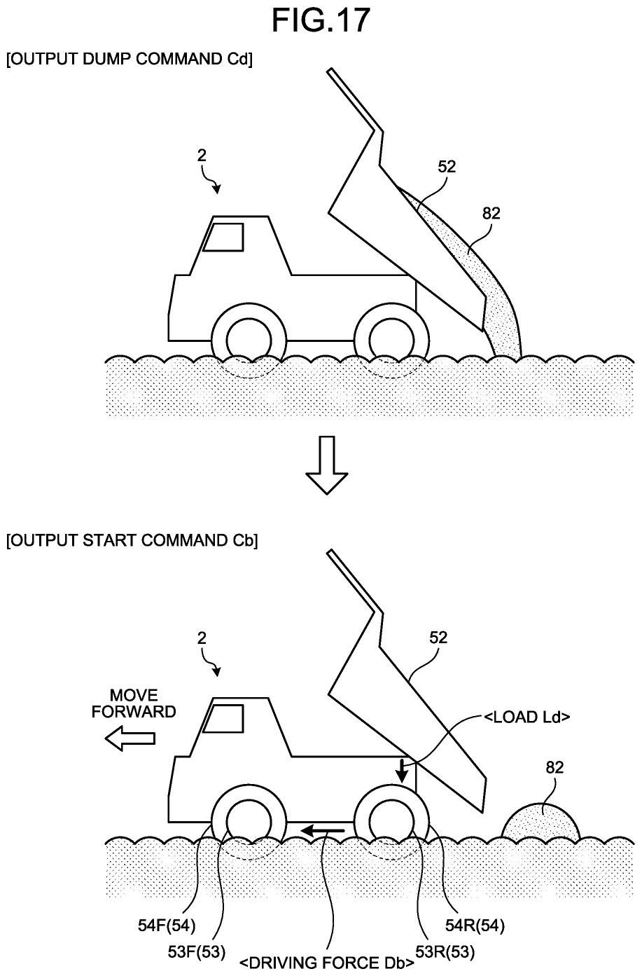

FIG. 17 is a diagram for explaining start control according to the embodiment. In the above-described embodiment, the dump body 52 performs the dumping operation in the state where the driving force db is generated. The travel control unit 104 may generate the driving force db for starting the unmanned vehicle 2 after the end of the dumping operation.

When it is determined that the unmanned vehicle 2 does not start in spite of the start command Ca, the dump body control unit 107 outputs the dump command Cd. When the dump command Cd is output, the dump body 52 performs a dumping operation from the loading posture. The load 82 loaded on the dump body 52 is discharged from the dump body 52. In the dumping operation, the start command Cb is not output. That is, the driving force db is not generated in the dumping operation.

When the dumping operation is ended and the dump body 52 takes the dump posture, the load Ld applied to the rear wheel 53R increases.

After the dumping operation is ended and the dump body 52 takes the dump posture, the travel control unit 104 outputs the start command Cb. When the start command Cb is output, the driving force db for starting the unmanned vehicle 2 is generated. When the driving force db is generated in a state where the load Ld applied to the rear wheel 53R is large, the unmanned vehicle 2 can start.

In the above-described embodiment, when it is determined that the unmanned vehicle 2 does not start in spite of the start command Ca, the dump body 52 performs the dumping operation in a state where the load 82 is loaded. When it is determined that the unmanned vehicle 2 does not start in spite of the start command Ca, the dump body 52 may perform the dumping operation in a state where the load 82 is not loaded. Even when the load 82 is not loaded on the dump body 52, the dump body 52 in the loading posture performs the dumping operation, and thus, a moment around the center of gravity of the vehicle body 50 changes or a load distribution acting on the hoist cylinder 62 changes, and a load applied to the front wheel 53F and the rear wheel 53R changes, so that the load Ld applied to the rear wheel 53R, which is the drive wheel, increases.

In the above-described embodiment, the dump body control unit 107 inclines the dump body 52 backward in the state where the driving force db for moving the unmanned vehicle 2 forward is generated to generate the assisting force Dc for moving the unmanned vehicle 2 forward. The dumping direction of the dump body 52 may not be the rear direction of the vehicle body 50. The dump body 52 may perform the dumping operation in the dumping direction opposite to the movement direction of the unmanned vehicle 2 by the driving force db.

In the above-described embodiment, the dump body control unit 107 outputs the dump command Cd in a state in which the front wheel 53F is in the straight traveling state. The dump body control unit 107 may output the dump command Cd in a state in which the front wheel 53F is in the non-straight traveling state.

In the above-described embodiment, the drive wheel is the rear wheel 53R, and the steering wheel is the front wheel 53F. The drive wheel may be the front wheel 53F or may be both the front wheel 53F and the rear wheel 53R. The steering wheel may be the rear wheel 53R or may be both the front wheel 53F and the rear wheel 53R.

In the above-described embodiment, when the start determination unit 106 determines that the unmanned vehicle 2 does not start in spite of the start command Ca, the dump body control unit 107 outputs the dump command Cd for causing the dump body 52 to perform the dumping operation. The dump body control unit 107 may output the dump command Cd based on the control command transmitted from the management device 21. For example, when the administrator of the control facility 13 determines that the unmanned vehicle 2 does not start in spite of the start command Ca, the dump body control unit 107 can cause the dump body 52 to perform a dumping operation based on the control command transmitted from the management device 21. In addition, the dump body control unit 107 may output the dump command Cd based on the operation command transmitted from the auxiliary vehicle 3. For example, when the driver of the auxiliary vehicle 3 determines that the unmanned vehicle 2 does not start in spite of the start command Ca, the dump body control unit 107 can cause the dump body 52 to perform a dumping operation based on the control command transmitted from the control device 40 of the auxiliary vehicle 3.

In the above-described embodiment, the start condition is generated by the start condition generation unit 105. The start condition may be generated by an arithmetic processing device different from the control device 30. The start condition generated by the arithmetic processing device may be stored in the start condition storage unit 112. The travel control unit 104 can perform start control of the unmanned vehicle 2 using the start condition stored in the start condition storage unit 112.

In the above-described embodiment, at least some of the functions of the control device 30 may be provided in the management device 21, or at least some of the functions of the management device 21 may be provided in the control device 30. For example, in the above-described embodiment, the management device 21 may have the function of the start condition generation unit 105. The start condition may be transmitted from the management device 21 to the control device 30 of the unmanned vehicle 2 via the communication system 24. The travel control unit 104 can perform start control of the unmanned vehicle 2 using the start condition transmitted from the management device 21. In addition, the management device 21 may have functions of, for example, the start determination unit 106, the vehicle situation determination unit 108, and the surrounding situation determination unit 109.

In the above-described embodiment, each of the course data acquisition unit 101, the permitted area data acquisition unit 102, the sensor data acquisition unit 103, the travel control unit 104, the start condition generation unit 105, the start determination unit 106, the dump body control unit 107, the vehicle situation determination unit 108, the surrounding situation determination unit 109, the permitted area change request unit 110, the notification unit 111, and the start condition storage unit 112 may be configured by discrete hardware.

In the above-described embodiment, the unmanned vehicle 2 may be a mechanically driven dump truck or an electrically driven dump truck.

### REFERENCE SIGNS LIST

1 WORK SITE
2 UNMANNED VEHICLE
2A ANOTHER UNMANNED VEHICLE
3 AUXILIARY VEHICLE
4 TRAVEL AREA
5 LOADING AREA
6 DISCHARGING AREA
7 PARKING AREA
8 FUEL FILLING AREA
9 TRAVELING PATH
10 INTERSECTION
11 LOADER
12 CRUSHER
13 CONTROL FACILITY
14 COURSE POINT
15 TRAVEL COURSE
16 PERMITTED AREA
17 STOP POINT
20 MANAGEMENT SYSTEM
21 MANAGEMENT DEVICE
21A PROCESSOR
21B MAIN MEMORY
21C STORAGE
21D INTERFACE
21E COMPUTER PROGRAM
22 INPUT DEVICE
23 OUTPUT DEVICE
24 COMMUNICATION SYSTEM
24A WIRELESS COMMUNICATION DEVICE
24B WIRELESS COMMUNICATION DEVICE
24C WIRELESS COMMUNICATION DEVICE
30 CONTROL DEVICE
30A PROCESSOR
30B MAIN MEMORY
30C STORAGE
30D INTERFACE
30E COMPUTER PROGRAM
40 CONTROL DEVICE
40A PROCESSOR
40B MAIN MEMORY
40C STORAGE
40D INTERFACE
40E COMPUTER PROGRAM
41 POSITION SENSOR
42 OUTPUT DEVICE
50 VEHICLE BODY
51 TRAVELING DEVICE
52 DUMP BODY
53 WHEEL
53F FRONT WHEEL
53R REAR WHEEL
54 TIRE
54B LOWER END PORTION
54F FRONT TIRE
54R REAR TIRE
55 DRIVE DEVICE
56 BRAKE DEVICE
57 TRANSMISSION DEVICE
58 STEERING DEVICE
59 POWER TRANSMISSION MECHANISM
60 HYDRAULIC DEVICE
61 STEERING CYLINDER
62 HOIST CYLINDER
63 HYDRAULIC PUMP
64 VALVE DEVICE
71 POSITION SENSOR
72 AZIMUTH SENSOR
73 INCLINATION SENSOR
74 SPEED SENSOR
75 STEERING SENSOR
81 ROAD SURFACE
82 LOAD
83 ESTIMATED AREA
84 DISCHARGE AREA
100 CONTROL SYSTEM
101 COURSE DATA ACQUISITION UNIT
102 PERMITTED AREA DATA ACQUISITION UNIT
103 SENSOR DATA ACQUISITION UNIT
104 TRAVEL CONTROL UNIT
105 START CONDITION GENERATION UNIT
106 START DETERMINATION UNIT
107 DUMP BODY CONTROL UNIT
108 VEHICLE SITUATION DETERMINATION UNIT
109 SURROUNDING SITUATION DETERMINATION UNIT
110 PERMITTED AREA CHANGE REQUEST UNIT
111 NOTIFICATION UNIT
112 START CONDITION STORAGE UNIT
211 COURSE DATA GENERATION UNIT
212 PERMITTED AREA SETTING UNIT
213 OUTPUT CONTROL UNIT
Ca START COMMAND
Cb START COMMAND
Cd DUMP COMMAND
Ce LOWERING COMMAND
Cr REQUEST COMMAND
Da DRIVING FORCE
Db DRIVING FORCE
Dc ASSISTING FORCE
Ld LOAD
PA PITCH AXIS
Pθ PITCH ANGLE
RA ROLL AXIS
Rθ ROLL ANGLE
T SPECIFIED TIME
ta TIME POINT
tb TIME POINT
Va COMMAND VALUE
Vb COMMAND VALUE
YA YAW AXIS
Yθ YAW ANGLE
θ INCLINATION ANGLE.

1. An unmanned vehicle control system comprising:
a travel control unit that outputs a start command for starting an unmanned vehicle; and
a dump body control unit that outputs a dump command for causing a dump body of the unmanned vehicle to perform a dumping operation when it is determined that the unmanned vehicle does not start in spite of the start command.

2. The unmanned vehicle control system according to claim 1, wherein
the dump body control unit outputs the dump command in a state where a load is loaded on the dump body.

3. The unmanned vehicle control system according to claim 1, wherein
the dump body control unit outputs the dump command in a state where a driving force for starting the unmanned vehicle is generated.

4. The unmanned vehicle control system according to claim 1, wherein
the travel control unit generates a driving force for starting the unmanned vehicle after an end of the dumping operation.

5. The unmanned vehicle control system according to claim 3, wherein
the driving force starts the unmanned vehicle in a predetermined movement direction, and
the dumping operation includes inclining the dump body in a dumping direction opposite to the movement direction.

6. The unmanned vehicle control system according to claim 5, wherein
the unmanned vehicle includes a drive wheel, and
a load applied to the drive wheel after the dumping operation is started is larger than a load applied to the drive wheel before the dumping operation is started.

7. The unmanned vehicle control system according to claim 1, wherein
the unmanned vehicle includes a steering wheel, and
the dump body control unit outputs the dump command in a state in which the steering wheel is in a straight traveling state.

8. The unmanned vehicle control system according to claim 1, further comprising:
a vehicle situation determination unit that determines whether the dumping operation is allowed to be started based on a vehicle situation of the unmanned vehicle before the dumping operation is started, wherein
the dump body control unit outputs the dump command based on a result of determination by the vehicle situation determination unit.

9. The unmanned vehicle control system according to claim 8, wherein
the vehicle situation includes a posture of a vehicle body of the unmanned vehicle that supports the dump body.

10. The unmanned vehicle control system according to claim 1, further comprising:
a surrounding situation determination unit that determines whether the dumping operation is allowed to be started based on a surrounding situation of the unmanned vehicle before the dumping operation is started, wherein
the dump body control unit outputs the dump command based on a result of determination by the surrounding situation determination unit.

11. The unmanned vehicle control system according to claim 10, wherein
the surrounding situation determination unit calculates an estimated area of a load discharged from the dump body by the dumping operation before the dumping operation is started, and
the surrounding situation includes at least one of course data of a moving object around the unmanned vehicle with respect to the estimated area and a position of the moving object around the unmanned vehicle with respect to the estimated area.

12. The unmanned vehicle control system according to claim 1, wherein
a permitted area in which the unmanned vehicle is permitted to travel is set,
the unmanned vehicle control system comprises a permitted area change request unit that requests expansion of the permitted area in a case where it is determined that the unmanned vehicle does not start in spite of the start command, and
the dump body control unit outputs the dump command after the permitted area is expanded.

13. The unmanned vehicle control system according to claim 1, further comprising:
a notification unit that notifies a target outside the unmanned vehicle that the dumping operation is to be started before the dumping operation is started.

14. The unmanned vehicle control system according to claim 13, wherein
the target includes a course data generation unit that generates course data of the moving object,
the notification unit makes a notification of an estimated area of a load discharged from the dump body by the dumping operation, and
the course data generation unit generates the course data based on the estimated area.

15. The unmanned vehicle control system according to claim 1, further comprising:
a notification unit that notifies a target outside the unmanned vehicle that the dumping operation has ended.

16. The unmanned vehicle control system according to claim 13, wherein
the target includes a course data generation unit that generates course data of the moving object,
the notification unit makes a notification of a discharge area of a load discharged from the dump body by the dumping operation, and
the course data generation unit generates the course data based on the discharge area.

17. An unmanned vehicle comprising:
the unmanned vehicle control system according to claim 1.

18. An unmanned vehicle control method comprising:
outputting a start command for starting an unmanned vehicle; and
outputting a dump command for causing a dump body of the unmanned vehicle to perform a dumping operation when it is determined that the unmanned vehicle does not start in spite of the start command.

19. The unmanned vehicle control method according to claim 18, further comprising
outputting the dump command in a state where a load is loaded on the dump body.

20. The unmanned vehicle control system according to claim 4, wherein
the driving force starts the unmanned vehicle in a predetermined movement direction, and
the dumping operation includes inclining the dump body in a dumping direction opposite to the movement direction.

21. The unmanned vehicle control system according to claim 20, wherein
the driving force starts the unmanned vehicle in a predetermined movement direction, and
the dumping operation includes inclining the dump body in a dumping direction opposite to the movement direction.
